(19) United States
(12) Patent Application Publication
(10) Pub. No.: US 2020/0124230 A1
(43) Pub. Date: Apr. 23, 2020

(54) ADHESIVE MOUNTING DEVICES HAVING PATTERNED ADHESIVE REGIONS

(71) Applicant: 3M INNOVATIVE PROPERTIES COMPANY, St. Paul, MN (US)

(72) Inventors: Joseph A. Hoffman, Minneapolis, MN (US); Margaret M. Sheridan, Woodbury, MN (US); Craig D. Thompson, Inver Grove Heights, MN (US); Brett P. Krull, Saint Anthony, MN (US); Michael B. Runge, Stillwater, MN (US)

(21) Appl. No.: 16/626,209

(22) PCT Filed: Jun. 26, 2018
(86) PCT No.: PCT/US2018/039553

§ 371 Date: Dec. 23, 2019

Related U.S. Application Data
(60) Provisional application No. 62/526,200, filed on Jun. 28, 2017.

(51) Int. Cl. F16M 13/02; B32B 7/14

(52) U.S. Cl. CPC F16M 13/02; B32B 2405/00; B32B 7/14

(57) ABSTRACT

The present disclosure generally relates to adhesive mounting assemblies that are capable of attaching or adhering to a surface and that can be removed from the surface without causing damage to the surface. In some embodiments, the mounting assemblies are peeled off the surface. The present disclosure generally relates to adhesive articles including a mounting device. The adhesive articles have one or more adhesive regions (which can be part of one continuous adhesive layer) exhibiting adhesive properties and one or more non-adhesive regions that lack significant adhesive properties. At least one of the non-adhesive regions is positioned relative to a corresponding adhesive region and/or has a geometry that lowers and/or controls at least one of the average peel force and/or or the peak peel force of the adhesive article such that the peel force of the adhesive article does not exceed the threshold for causing damage to the surface from which the adhesive article is peeled.

### TECHNICAL FIELD

The present disclosure generally relates to adhesive mounting devices that are capable of attaching or adhering to a surface and that can be peeled off the surface without causing damage to the surface. The present disclosure also generally relates to methods of making and using such adhesive mounting devices.

### BACKGROUND

The revolutionary Command® Adhesive Strip products are a line of stretch releasable adhesive strips that holds strongly on a variety of surfaces (including paint, wood, and tile) and that remove cleanly—no holes, marks, or sticky residue. In general, these products include a stretch release pressure sensitive adhesive composition disposed on tape or other backings. These products generally have utility in bonding to various surfaces or substrates for numerous applications. Stretch-release products are designed to firmly adhere an article, such as a hook (to hold a picture or an article of clothing) or other decorative or utilitarian element, to a surface (an adherend), yet remove cleanly when pulled away from the surface at a low angle. The clean removal aspect is so that a tacky and/or unsightly residue is not left behind on the surface after removal of the stretch release adhesive. During the process of stretch release removal, the adhesive layer preferably remains adhered to the tape backing as the backing is stretched, but releases from the surface (adherend).

Peelable adhesive technology was recently introduced into products for mounting. Some exemplary commercially available peelable mounting products (e.g., Jimmy Hook™ products, GeckoTech™ products, Elmer's Freestyle™ products, and Hook Um™ products) rely on both suction technology and frictional or dry adhesives to generate the mounting device's holding power. The mounting devices include a semi-rigid plastic backing and a rigid hook, both of which are integrated as a one-piece article support. The rigid hook is permanently attached to a first major planar surface of the semi-rigid plastic backing. The second major planar surface of the backing can be adhered to a wall surface. The second major planar surface includes one or more of suction technology (e.g., numerous microsuction or nanosuction elements) and/or a frictional adhesive (in which the backing is impregnated with a rubber-based adhesive to increase friction between the substrate and backing) or dry adhesive (which relies on van der Waals forces). The entire construction can, thereafter, be removed by peeling.

### SUMMARY

The inventors of the present disclosure recognized that the existing peelable mounting products suffered from various disadvantages. Because of their low adhesiveness, the existing peelable mounting products did not consistently work. Further, they did not work well on painted surfaces or rough surfaces (e.g., drywall). Additionally, the existing peelable mounting products have low shear strength and thus can hold little weight.

The inventors of the present disclosure sought to formulate peelable mounting products and/or adhesive articles with at least one of higher shear strength, that work well on painted or rough surfaces, that are capable of consistently holding higher weights, and/or that leave minimal or low residue, all without damaging the surface to which they are applied.

The inventors of the present disclosure also recognized that peelable adhesive articles can be attached or adhered to a mounting device (e.g., a hook or clip). In such implementations, the mounting device is typically bonded to the top side of a backing and the bottom side of the backing typically includes an adhesive capable of adhering the backing to a surface. To cleanly peel the mounting article/mounting assembly from the surface requires that peel separation be maintained across the entire assembly. The inventors recognized that one way to maintain the peel separation is to form a mounting article/mounting assembly that lacks active adhesive in at least a portion of the area under or adjacent to at least a portion of the mounting device. In some embodiments, the mounting article/mounting assembly can either lack adhesive in this area or the adhesive in this area can be deadened. In some embodiments, the mounting assembly has a lower stiffness or modulus portion adjacent to an active adhesive and a higher stiffness or modulus portion adjacent to an area that lacks an active adhesive.

The present disclosure generally relates to various embodiments of a peelable adhesive article and/or assembly including a mounting device. The entire construction can be peeled off a surface without damaging the surface. The peelable adhesive articles or assemblies described herein generally have adhesive areas including a pressure sensitive adhesive and non-adhesive areas that lack significant adhesive properties. The non-adhesive areas are located in an area and/or have a size, shape, and/or geometry that lowers and/or controls at least one of the average peel force and/or the peak peel force of the adhesive article such that the peel force of the adhesive article does not exceed the threshold for causing damage to the substrate from which the adhesive article is peeled. In some embodiments, the non-adhesive areas are adjacent to or aligned with at least a portion of an adhesive area on the opposing surface of the backing. Some embodiments relate to an adhesive mounting assembly, comprising: a backing including opposing first and second major planar surfaces separated by a thickness; a first adhesive region on the first major planar surface of the backing, the first adhesive region exhibiting adhesive properties; a first non-adhesive region on the second major planar surface of the backing, the non-adhesive region lacking significant adhesive properties and directly opposed to first adhesive region; and a mounting device adjacent to the backing second major surface of the backing.

Some embodiments relate to a method of forming an adhesive mounting assembly, comprising: providing a backing including opposing first and second planar surfaces separated by a thickness; forming a first adhesive region and a first non-adhesive region on the first major planar surface of the backing; the first adhesive regions including a peelable adhesive; forming a second adhesive region and a second-non-adhesive region on the second major surface of the backing to create a master sheet; providing a mounting device having a major surface with a first geometry; and removing a portion of the master sheet corresponding to the first geometry to create a discrete backing; and placing the backing adjacent to the major surface of the mounting device.

Some embodiments relate to a method of using an adhesive mounting device, comprising: adhering any of the adhesive mounting assemblies described herein to a surface; and removing the adhesive article from the surface. In some embodiments, removing a release liner from the adhesive mounting assembly before adhering it to the surface. In some embodiments, the method involved gripping a tab portion of the adhesive mounting assembly and lifting it to begin or progress the process of removing the adhesive mounting assembly from the surface. In some embodiments, removal of the adhesive article from the surface involves peeling the adhesive article from the surface.

In some embodiments, the mounting device is at least one of a hook, clip, magnet, snap, loop, or detachable mechanical fastener. In some embodiments, the adhesive region includes an adhesive that includes at least one of natural rubber, synthetic rubber such as SBS, SIS, SEBS, acrylate, polyurethane, silicone, silicone block copolymers, and combinations thereof. In some embodiments, the adhesive region includes an adhesive that includes a tackifier selected from a list consisting essentially of terpene phenol, polyterpene, rosin esters, rosin acids, C5 tackifiers, and/or C9 tackifiers.

In some embodiments, the backing is at least one of a single layer film or a multilayer film. In some embodiments, the backing exhibits an elastic recovery of 1-99% at 10% strain. In some embodiments, the backing exhibits an elastic recovery of 1-99% at 20% strain. In some embodiments, the backing has a thickness of between about 0.1 mil and about 100 mils.

In some embodiments, the non-adhesive region includes a deadening layer that substantially diminishes the adhesive properties of the adhesive and wherein the deadening layer is located adjacent to the adhesive. In some embodiments, the deadening layer has a thickness of between about 0.1 mil and about 10 mils. In some embodiments, the deadening layer comprises at least one of a coating, a film, ink, lacquer, and/or a chemical reaction initiated by radiation.

In some embodiments, the adhesive is peelable. In some embodiments, the non-adhesive region comprises between about 10% and about 90% percent of a total adhesive article area. In some embodiments, the non-adhesive region comprises between about 15% and about 45% percent of a total adhesive article area. In some embodiments, the adhesive region comprises between about 10% and about 90% area percent of a total adhesive article area. In some embodiments, the adhesive region comprises between about 20% and about 80% percent of a total adhesive article area. In some embodiments, the adhesive region has a width extending between first and second opposed side ends of the backing, and the width of the adhesive region decreases as the adhesive region approaches a tab and/or a first terminal end of the backing.

In some embodiments, the mounting device is capable of holding at least 0.3 pounds. In some embodiments, the assembly has a sheer capacity of at least 1 lb. per square inch.

In some embodiments, the non-adhesive region at least one of (1) lacks a pressure sensitive adhesive; (2) includes a deadening layer that minimizes or eliminates the adhesion of the pressure sensitive adhesive in the non-adhesive region; and/or (3) has undergone an adhesive degradation process. In some embodiments, the adhesive degradation process is one of radiation exposure, UV, ebeam, or other chemical transformations.

As used herein “geometry” refers to the size and shape of an element or feature.

As used herein, “layer” means a single stratum that may be continuous or discontinuous over a surface.

As used herein, the terms “top” and “bottom” are for illustrative purposes only, and do not necessarily define the orientation or the relationship between the various layers of the adhesive articles describe herein. Accordingly, the terms “top” and “bottom” should be considered interchangeable.

As used herein, the term “pitch” identifies the distance between the centroids of adjacent adhesive or non-adhesive features or regions. The pitch is measured from the centroid of a feature or region (i.e., the geometric center) to the centroid of an adjacent feature or region of like adhesive (or non-adhesive) character.

The terms “comprises” and variations thereof do not have a limiting meaning where these terms appear in the description and claims.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As recited herein, all numbers should be considered modified by the term “about”.

As used herein, “a,” “an,” “the,” “at least one,” and “one or more” are used interchangeably. Thus, for example, a core comprising “a” pattern of recesses can be interpreted as a core comprising “one or more” patterns.

Also herein, the recitations of numerical ranges by endpoints include all numbers subsumed within that range (e.g., 1 to 5 includes 1, 1.5, 2, 2.75, 3, 3.80, 4, 5, etc.).

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

The above summary of the present disclosure is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exhaustive list.

### BRIEF DESCRIPTION OF DRAWINGS

FIG. 1A-1C are respective perspective, side, and back views of an adhesive mounting assembly;

FIG. 2 is a perspective view of an adhesive mounting assembly in accordance with the present disclosure;

FIG. 3 is a cross-sectional view of the adhesive mounting assembly of FIG. 2.

FIG. 4 is a perspective view of an adhesive mounting assembly per another embodiment of the present disclosure;

FIG. 5 is an exploded perspective view of a disassembled adhesive mounting assembly of FIG. 4;

FIG. 6 is a cross-sectional view of the adhesive mounting assembly of FIGS. 4 and 5;

FIG. 7 is a front view of an inverse pair of adhesive distributions as used with the adhesive mounting assembly of FIGS. 4-6;

FIGS. 8A & 8B illustrate a side view of a mounting assembly of FIGS. 4-6 being removed from a surface.

FIG. 9 is a front view of an inverse pair of adhesive distributions per another embodiment of the present disclosure;

FIG. 10 is a front view of an inverse pair of adhesive distributions per another embodiment of the present disclosure;

FIG. 11 is a front view of an inverse pair of adhesive distributions per another embodiment of the present disclosure;

FIG. 12 is an exploded perspective view of a disassembled adhesive mounting assembly according to an embodiment of the present disclosure;

FIG. 13 is a is a cross-sectional view of the adhesive mounting assembly of FIG. 12;

FIG. 14 is a flowchart depicting an exemplary method of manufacturing the adhesive mounting assemblies of the present disclosure;

FIG. 15 is a top plan view of a master sheet suitable for creating a plurality of adhesive coated backings;

FIG. 16 is a top plan view illustration of the creation of individual backings for registration with a mounting device; and

FIG. 17 is a top plan view illustration of the creation of individual backings for registration with a mounting device.

FIG. 18 is a graph representing the maximum peel force and damage rating of exemplary and comparative mounting assembly constructions.

Layers in certain depicted embodiments are for illustrative purposes only and are not intended to absolutely define the thickness, relative or otherwise, or the absolute location of any component. While the above-identified figures set forth several embodiments of the disclosure other embodiments are also contemplated, as noted in the description. In all cases, this disclosure is presented by way of representation and not limitation. It should be understood that numerous other modifications and embodiments can be devised by those skilled in the art, which fall within the scope and spirit of the principles of the disclosure.

### DETAILED DESCRIPTION

Various embodiments and implementations will be described in detail. These embodiments should not be construed as limiting the scope of the present application in any manner, and changes and modifications may be made without departing from the spirit and scope of the inventions. Further, only some end uses have been discussed herein, but end uses not specifically described herein are included within the scope of the present application. As such, the scope of the present application should be determined by the claims.

The present disclosure generally relates to adhesive articles that can be peeled off a substrate without damage. As used herein, the term “peelable” means that the adhesive article can be removed from a substrate or surface by peeling at angle of between about 1° and about 180°. In some embodiments, the adhesive article can be removed from a substrate or surface by peeling at angle of between 30° to 120°. In some embodiments, the adhesive article can be removed from a substrate or surface by peeling at angle of at least about 35°. Peelable adhesive articles were described in, for example, International Publication No. 2015/034104.

As used herein, the terms “without damage” and “damage-free” or the like means the adhesive article can be separated from the substrate without causing visible damage to paints, coatings, resins, coverings, or the underlying substrate and/or leaving behind residue. Visible damage to the substrates can be in the form of, for example, scratching, tearing, delaminating, breaking, crumbling, straining, and the like to any layers of the substrate. Visible damage can also be discoloration, weakening, changes in gloss, changes in haze, or other changes in appearance of the substrate.

The adhesive articles have adhesive regions including an at least peelable adhesive and non-adhesive regions that lack significant or any adhesive properties. As used herein, the term “non-adhesive regions” refers to one or more regions of the adhesive article having a reduction in adhesive properties (peel adhesion or tack) as compared to the adhesive region(s) ranging from about 90% to about 100% as measured by ASTM D3330/3330M-04 (for peel adhesion) and/or ASTM D2979-01 (2009) (probe tack). In presently preferred implementations, the non-adhesive region article has a reduction in adhesive properties (peel adhesion or tack) as compared to the adhesive region(s) ranging from about 95% to about 100%; in other implementations, particularly those suitable for use with at least one of delicate and textured surfaces, the non-adhesive region(s) have a reduction in adhesive properties (peel adhesion or tack) as compared to an adhesive region(s) of at least about 99%.

The mounting assemblies of the present disclosure may include a backing or may be backing free. Backing free adhesive constructions are described, for example, in US Publication No. 2016/0068722 (Schmitz-Stapela et al.); such embodiments may include adhesive and non-adhesive regions of the type described herein on either side of an adhesive core.

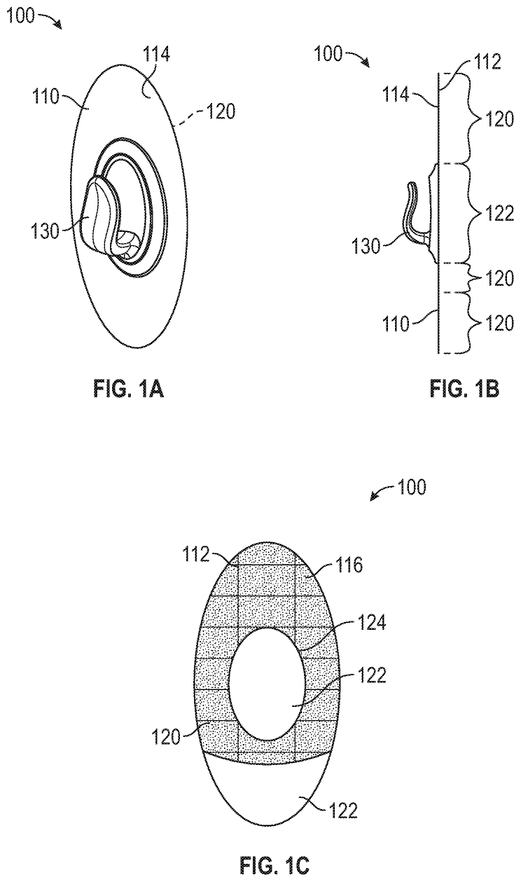

An adhesive article featuring non-adhesive and adhesive regions is depicted in FIGS. 1A and 1B. Adhesive mounting device 100 includes a backing 110 including first and second opposed major surfaces 112 and 114. A mounting device 130 is disposed adjacent the second major surface 114 of the backing 110. An adhesive region 120 of first major surface 112 is coated with an adhesive. The illustrated embodiment of adhesive region 120 includes a generally ovular shape, however, an adhesive region 120 can take the form of any shape.

A non-adhesive region 122 of first (or rear) major surface 112 of backing 110 lacks adhesive functionality and/or is not significantly adhesive. The adhesive region 120 surrounds the non-adhesive region 122, defining a boundary 124 between the adjacent regions 120, 122. As depicted, the adhesive region 120 extends from the boundary 124 to the perimeter 116 of the backing 110. The mounting device 130 is coupled to the second major surface 114 of the backing.

The non-adhesive areas have a location and/or have a size, shape, and/or geometry that lowers and/or controls at least one of the average peel force and/or the peak peel force of the adhesive article such that the peel force of the adhesive article does not exceed the threshold for causing damage to the substrate from which the adhesive article is peeled. In some embodiments, the average peel force and/or the peak peel force is 30 oz or less. In some embodiments, the average peel force and/or the peak peel force is 35 oz or less. In some embodiments, the average peel force and/or the peak peel force is 40 oz or less. In some embodiments, the average peel force and/or the peak peel force is 45 oz or less. In some embodiments, the average peel force and/or the peak peel force is 50 oz or less.

The inventors of the present disclosure recognized that peel removal of a peelable adhesive article has two distinct phases: (1) the peel front initiation which corresponds to a kinetic peel force and/or a peak peel force; and (2) the propagation along the adhesive backing of the peel front, which corresponds to the average peel force. The average peel force is typically lower, and sometimes significantly lower, than the peak peel force. When the adhesive article is peeled off or from a surface that is damageable, the area subject to the peak peel force is where damage is frequently observed. Often this peak peel force exceeds or is greater than the threshold for causing damage. When the peel force exceeds the threshold for causing damage, undesirable substrate or surface damage occurs.

The inventors of the present application further discovered that by tailoring the geometry and relative locations of the non-adhesive and/or adhesive region(s) on the adhesive assembly, the peel forces can be affected. More specifically, the peel forces can be tailored or altered so that they do not exceed the damage threshold of the substrates on which the adhesive assembly will be used or adhered.

The inventors of the present disclosure then found that including a non-adhesive region on the directly opposite side of the backing from an adhesive region provides an adhesive article with a peak peel force that does not exceed the damage threshold on substrates including, for example, drywall, paint, glass, etc. As such, the inventors of the present disclosure found adhesive mounting assemblies that can be adhered to and peeled from various substrates, including delicate surfaces, without causing damage. These adhesive mounting assemblies can hang or mount articles of various weights.

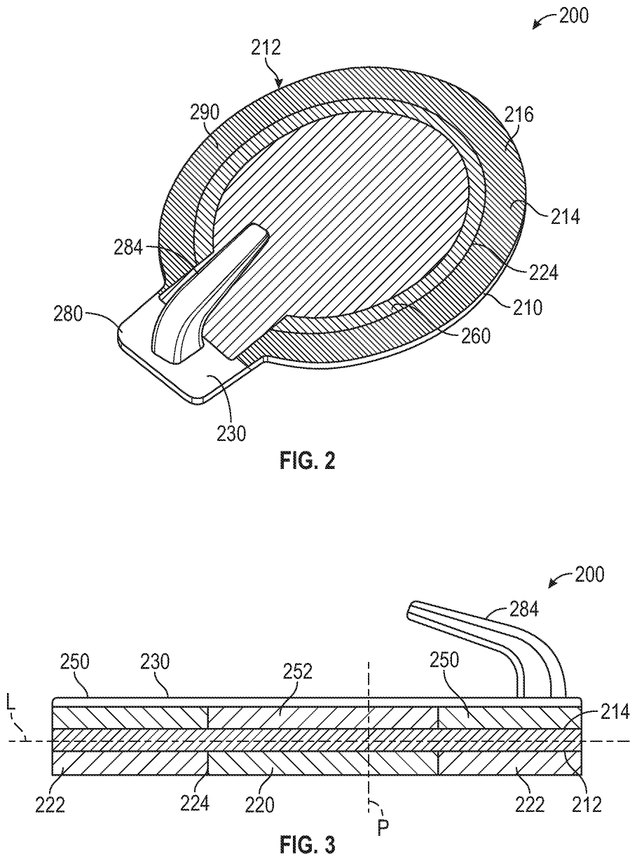

One exemplary embodiment of an adhesive mounting assembly of the type described herein is shown in FIGS. 2 and 3. Adhesive mounting assembly 200 includes a backing 210 including first and second opposed major surfaces 212 and 214. The backing 210 is typically at least substantially planar, with each major surface 212, 214 residing in substantially parallel planes. A mounting device 230 is disposed adjacent the second major surface 214 of the backing 210. Mounting device 230 includes a hook portion 280 with a hook 284 and a flange portion 290. In the embodiment of FIGS. 2-3, a rear surface of flange portion 290 and hook portion 280 attaches to or mates with a complementary portion of backing 210. The flange portion 290 is at least substantially coextensive with the second major surface 214 of backing 210. In other embodiments, at least a portion of the flange portion 290 and/or the hook portion 280 can extend beyond an edge of the backing 210, and vice versa.

An adhesive region 220 of first major surface 212 is coated with an adhesive. The illustrated embodiment of adhesive region 220 includes a generally ovular shape, however, an adhesive region 220 according to the present disclosure can take the form of any shape. Non-limiting examples of other shapes that are suitable for an adhesive region include circles, triangles, squares, rectangles, and other polygons (both regular and irregular).

A non-adhesive region 222 of first (or rear) major surface 212 of backing 210 lacks adhesive functionality and/or is not significantly adhesive. The non-adhesive region 222 partially surrounds the adhesive region 220, defining a boundary 224 between the adjacent regions 220, 222. As depicted, the non-adhesive region 222 extends from the boundary 224 to the perimeter 216 of the backing 210.

The mounting device 230 is coupled to the second major surface 214 of the backing by at least an adhesive region 250 coated with an adhesive. The adhesive region 250 on the second (front) surface 214 is at least coextensive with and corresponds in geometry to non-adhesive region 222 on the first major surface 212. Similarly, the non-adhesive region 252 on the front surface 214 is at least coextensive with and corresponds to the adhesive region 220 on the rear surface 212 of the backing 210. That is, the adhesive/non-adhesive character of a given region on a major surface will have its opposite disposed across the backing on the opposing major surface. Accordingly, the disposition of the adhesive/non-adhesive regions on the rear major surface 212 is essentially inverse to the disposition of adhesive/non-adhesive regions on the front major surface 214. This arrangement assures that no adhesive regions overlap with one another along an axis “L” extending through the thickness of the backing and normal to the major surface planes (see FIG. 3). Without wishing to be bound by theory, visible damage is often likely to occur during or after removal if a direct adhesive connection through the thickness of the adhesive article can be made between the wall surface (i.e., adhered) and the mounting device. By disrupting that link through non-overlapping (at least in parallel planes) adhesive regions, the present inventors found that the damage to various wall surfaces can be reduced or eliminated.

When distributed in inverse relationship on opposing sides of the backing, no adhesive region or element is coplanar with another adhesive region in a plane “P” extending through first and second major surfaces and substantially perpendicular the longitudinal axis “L” of the backing. Similarly, no non-adhesive region or element is coplanar with another non-adhesive region in a plane “P” extending through first and second major surfaces and substantially perpendicular the longitudinal axis “L” of the backing.

In presently preferred implementations of the present disclosure, non-adhesive region 252 on second major surface 214 comprises a similar geometry of larger surface area than corresponding adhesive region 220 on the rear surface 212. The geometric offset creates an overlap boundary 260 (made visible in FIG. 2). The use of an overlap boundary 260 can allow for manufacturing tolerance of equipment used to create the requisite regions, and can thus help ensure there is no adhesive having a direct path from the mounting device 230 to the wall surface or other adherend.

Many changes may be made to the specific embodiment shown in FIGS. 2 and 3. For example, the mounting device can be any desired mounting device. Multiple mounting devices can be present. The shape and size of the mounting device and/or backing can be any desired shape or size.

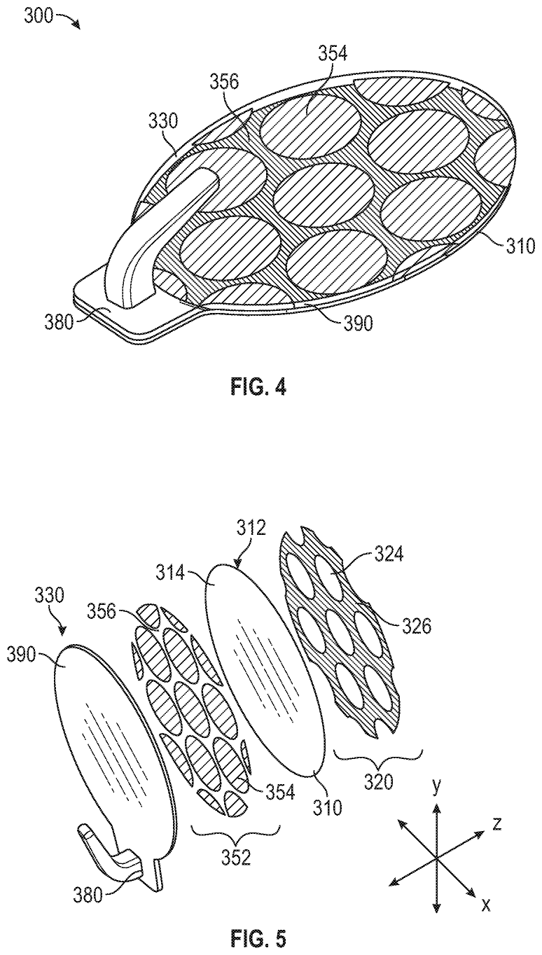

An adhesive article according to another embodiment of the present disclosure is depicted in FIGS. 4-7. Adhesive mounting device 300 includes a backing 310 including first and second opposed major surfaces 312 and 314. The backing 310 is at least substantially planar, with each major surface 312, 314 residing in substantially parallel planes. A mounting device 330 is disposed adjacent the second major surface 314 of the backing 310. Mounting device 330 includes a hook portion 380 and a flange portion 390. In the embodiment of FIGS. 4-7, a rear surface of flange portion 390 attaches to or mates with a complementary portion of backing 310. The flange portion 390 is at least substantially coextensive with the second major surface 314 of backing 310. In other embodiments, at least a portion of the flange 390 and/or the hook 380 can extend beyond an edge of the backing 310, and vice versa.

The first major surface 312 of the backing 310 includes an adhesive region 320 defined by a plurality of adhesive elements 324. The adhesive region 320 as depicted includes an arranged pattern of discrete adhesive elements or islands 324. An “arranged pattern” or “arranged distribution” is a plurality of elements arranged at predetermined positions, arranged with some degree of regularity, or arranged in any desired manner. The adhesive elements 324 are arranged in a hexagonal array, but other patterns and arrangements are possible, including unstructured arrays. In some embodiments, the patterns resemble or are a tessellation. In some embodiments, the adhesive elements 324 are distributed as a periodic array across a surface (e.g., a one-dimensional array or a two-dimensional array, for example a square array, hexagonal, or other regular array). For example, the arranged pattern of can include an arranged row pattern, an arranged lattice pattern such as an arranged square lattice pattern, an arranged zigzag pattern, an arranged radial pattern, and combinations thereof. The arranged pattern need not be formed evenly on the entire surface but may be formed in only a portion of the backing surface. The pattern of adhesive elements may vary or remain the same over any portion of the article. For example, similar or different patterns can be used across a given major surface. The features within the pattern can be of similar geometry or can have different geometries.

The islands 324 can take the form of any shape. The illustrated embodiment of first major surface 312 comprises a plurality of circular islands 324. Other, non-limiting examples of shapes that are suitable for adhesive islands 324 include parallelograms, parallelograms with rounded corners, rectangles, squares, circles, half-circles, ellipses, half-ellipses, triangles, trapezoids, stars, ovals, teardrops, other polygons (e.g., hexagons), etc., and combinations thereof. Each element includes a largest cross-sectional dimension. The size of the largest cross-sectional dimension is not particularly limited, but is typically at least 75 microns.

Additional suitable element shapes include irregular geometries that can be described by non-Euclidean mathematics. Non-Euclidean mathematics is generally used to describe those features whose mass is directly proportional to a characteristic dimension of the spaced feature raised to a fractional power (e.g., fractional powers such as 1.34, 2.75, 3.53, or the like). Examples of geometries that can be described by non-Euclidean mathematics include fractals and other irregularly shaped elements. For irregularly shaped features (e.g., features which are not parallelograms, regular polygons, or circles) the largest cross-sectional dimension will be understood to be the diameter of a circle of equivalent area.

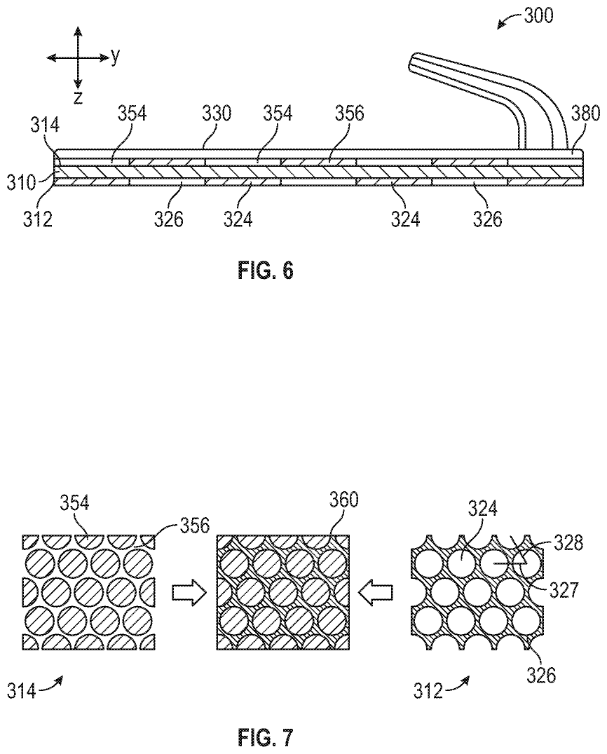

A Cartesian x-y-z coordinate system is included in FIGS. 5 and 6 for reference purposes. The first and second major surfaces 312, 314 of the backing 310 extend generally parallel to the x-y plane, and the thickness of the backing 310 corresponds to the z-axis. The array of adhesive islands 324 includes a transverse direction, generally along the x-axis and a longitudinal direction, generally along the y-axis. The arranged pattern includes a defined spacing or pitch between nearest-neighboring, adjacent adhesive islands 324. The pitch between adjacent islands 324 in an array or pattern may be the same in both the transverse direction and longitudinal direction. In other embodiments, the pitch along the transverse direction is less than the pitch along the longitudinal direction, and vice versa.

As exemplified in FIG. 7, the configuration of the adhesive islands 324 in any given region can be chosen so that the pitch 328 (i.e., the average centroid to centroid distance between nearest-neighboring, adjacent elements having like adhesive or non-adhesive character) is at least 5 millimeters, in other embodiments at least 10 millimeters, in other embodiments at least 20 millimeters, in other embodiments at least 25 millimeters, and in yet other embodiments at least 30 millimeters. In certain embodiments, the pitch is no greater than 70 millimeters, in some embodiments no greater than 60 millimeters, in some embodiments no greater than 50 millimeters, and in certain embodiments no greater than 45 millimeters.

As depicted, the islands 324 are discrete along both the transverse and longitudinal directions of the backing 310. In other embodiments, the adhesive elements 324 can be discrete along one direction, such that the elements resemble channels in the core, or may extend diagonally (relative to the orientation shown in e.g., FIG. 7) across the major surface 312 of the backing 310. Such channels can follow any desired path and can be continuous or discontinuous across a surface of the backing in any given direction.

The adhesive region 320 includes a plurality of islands 324 each having substantially the same geometry. In other embodiments, the size or shape of the islands 324 may change across the transverse direction, longitudinal direction, or combinations thereof. In yet other embodiments, the adhesive region 320 can include two or more elements or islands 324 of different geometries arranged in repeating unit cell. The unit cell can be repeated in an arranged pattern of unit cells on the rear surface 312. A variety of shapes may be used to define the unit cell, including rectangles, circles, half-circles, ellipses, half-ellipses, triangles, trapezoids, and other polygons (e.g., pentagons, hexagons, octagons), etc., and combinations thereof. In such embodiments, each unit cell boundary is directly adjacent the boundary of a neighboring unit cell, so that the plurality of unit cells resembles, e.g., a grid or tessellation.

As discussed above and seen in e.g., FIG. 5, the adhesive islands 324 are discreet, resulting in interstitial spaces 326 between any two adjacent islands 324. The interstitial spaces 326 lack adhesive functionality and/or are not significantly adhesive. Accordingly, the sum area of the interstitial spaces 326 defines the non-adhesive region 322 on the rear surface 312. In presently preferred implementations, the islands 324 are not closely packed, such that the boundaries of any individual island 324 are not directly adjacent, coincident, or overlapping the boundaries of any adjacent island 324. This provides sufficient interstitial space to realize the damage reduction and other benefits extolled below.

For any of the arranged distributions described herein for use on a rear surface of the backing, the area of contained within the plurality of adhesive elements or islands 324 is typically greater than the area bound within interstitial spaces 326. In some embodiments, at least 51% of the area of the rear surface is contained within the adhesive elements, in some embodiments at least 60% of the area, in some embodiments at least 75%, in some embodiments at least 80%, in some embodiments at least 85%, in some embodiments at least 90%, and in yet additional embodiments at least 95% of the area is contained within the adhesive elements 324.

The mounting device 330 is coupled to the second (front) major surface 314 of the backing by at least an adhesive region coated with an adhesive. Like the arrangement in adhesive article 200, the disposition of the adhesive/non-adhesive regions on the rear major surface 312 of backing 310 is essentially inverse to the disposition of adhesive/non-adhesive regions on the front major surface 314. Accordingly, the non-adhesive region 352 on the front major surface 314 is defined by a plurality of discrete non-adhesive elements or islands 354 arranged in the same pattern as the adhesive islands 324 on rear surface. That is, the adhesive/non-adhesive character of a given region on a major surface will have its opposite disposed directly across the backing on the opposing major surface. Each non-adhesive island 354 has a similar shape to its opposing adhesive island 324, but possesses a larger area to create an overlap boundary 360.

The interstitial spaces 356 are coated with an adhesive; the sum area of the interstitial spaces 356 defines the adhesive region on the front surface 314. The adhesive/non-adhesive arranged patterns for each major surface 312, 314 are shown in FIG. 7.

For any of the arranged distributions described herein for use on a front surface of the backing, the area of contained within the plurality of non-adhesive elements 354 is typically greater than the area bound within interstitial spaces 356. In some embodiments, at least 51% of the area of the rear surface is contained within the adhesive elements, in some embodiments at least 60% of the area, in some embodiments at least 75%, in some embodiments at least 80%, in some embodiments at least 85%, in some embodiments at least 90%, and in yet additional embodiments at least 95% of the area is contained within the non-adhesive elements 354.

An arrangement of relatively smaller adhesive elements within an adhesive region can provide several advantages for adhesive articles of the present disclosure. First, the creation of a perimeter around each adhesive element increases the resistance to undesirable stretching when the article is mounted to a vertical surface. This resistance enhances the ability of the adhesive articles to hang progressively heavier objects. Without wishing to be bound by theory, having a greater effective adhesive perimeter length within the same or comparable area of the major surface is correlated with an increase in the film's ability to support a load. Second, the distribution of discrete adhesive elements can further reduce the amount of stretch in the backing upon removal; rendering the adhesive article repositionable and/or reusable. In certain other designs of adhesive articles of the present disclosure featuring monolithic adhesive areas, the backing tends to stretch and sag upon removal, which can compromise the ability of a user to reaffix the adhesive article or trust the continued ability to rely on a prescribed weight claim.

Third, and as shown below, the distribution of discrete adhesive elements can, in certain circumstance, significantly reduce or eliminate the visible damages to particularly delicate surfaces (e.g., painted drywall, wallpaper, etc.) upon removal. Without wishing to be bound by theory, the distributed adhesive elements tend to sequentially release from an adherend upon application of a peel force instead of all at once. This may tend to reduce the stress on the adherend per any given area of contact with an adhesive element, despite the max peel force generated during removal being the same or greater. That reduction in stress, in turn, may result in less visible damage.

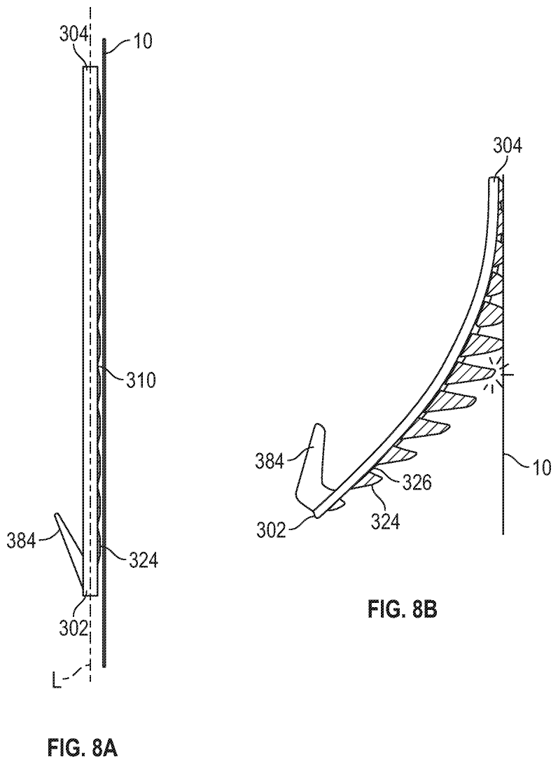

One form of sequential release of the adhesive elements upon removal from a surface is illustrated in FIGS. 8A and 8B. A mounting article 300 is shown in FIG. 8A affixed to a vertical surface 10. Each adhesive island 324 on the first major surface of the backing 310 is in adhesive contact with the surface 10. When peel removal is initiated at a terminal end 302 of the assembly 300 near hook 334 in FIG. 8B, the adhesive islands 324 can stretch and release in directions normal to the surface 10. The release of adhesive islands 324 propagates upward along the longitudinal axis “L” of the backing 310 until reaching opposing terminal end 304.

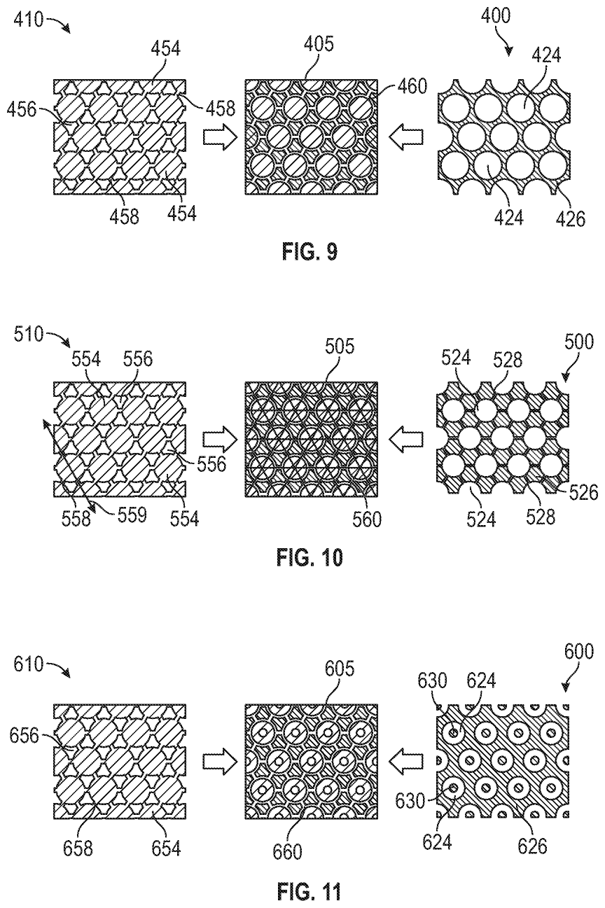

Another exemplary inverse pair of arranged distributions of adhesive and non-adhesive regions for use on opposing major surfaces of a backing are depicted in FIG. 9. The distributions can be used with any of the backings and mounting devices described herein and feature adhesive/non-adhesive elements arranged in opposing patterns. A first distribution 400 for use on a rear major surface of a backing (i.e., the surface opposing a mounting device) includes a plurality of adhesive elements 424. The first adhesive distribution 400 as depicted includes an arranged pattern of discrete, circular adhesive islands 424. The adhesive islands 424 are arranged as a tessellation, but other shapes, patterns and arrangements are also possible.

The interstitial spaces 426 lack adhesive functionality and/or are not significantly adhesive. Accordingly, the sum area of the interstitial spaces 426 defines the non-adhesive region of adhesive distribution 400, while the sum area of the adhesive islands defines the adhesive region.

A second distribution 410 can be used to couple a mounting device to the front major surface of a backing. A non-adhesive region includes a plurality of primary non-adhesive elements 454 arranged in the same pattern as the adhesive islands 424 in the first adhesive distribution. Each primary non-adhesive element 454 has a similar shape to its opposing adhesive island 424, but possesses a larger area to create an overlap boundary 460 when disposed on a backing opposite the first distribution 400 (seen in the overlap view in the central, opposed pattern 405).

Each primary non-adhesive element 454 is connected to each adjoining element 454 by a linking bridge 458. Each bridge 458 also lacks adhesive functionality and/or is not significantly adhesive. The bridges 458 operate to vent air from the exterior of the adhesive distribution 410 inward to the non-adhesive elements 454 in the center. Under certain conditions, the ventilation can prevent the formation of a vacuum between an adhesive and the backing. Without wishing to be bound by theory, the creation of a vacuum can inhibit the separation of the non-adhesive regions from the backing, potentially resulting in additional, visible damage upon attempted removal.

In other embodiments, a bridge 458 does not connect each primary non-adhesive element to every adjacent primary non-adhesive element. For example, the primary non-adhesive elements may be connected by bridges only along the transverse direction, the longitudinal direction, or diagonally across the requisite front surface of a backing. Alternatively, one portion of the distribution may include bridges in fluid communication with non-adhesive elements, while another may include only discrete non-adhesive islands.

Bridges 458 have a length dimension related to the pitch between adjacent primary non-adhesive elements 454. Each bridge 458 typically has a width of less than the pitch and/or the largest cross-sectional dimension of the primary non-adhesive elements 454 connected by a given bridge 458. In some embodiments, each channel has a width of no greater than 95% of the pitch and/or largest cross-sectional dimension of the connected primary adhesive elements, in some embodiments no greater than 75%, in some embodiments no greater than 55%, in some embodiments no greater than 35%, in some embodiments no greater than 15%, in some embodiments no greater than 10%, and in some embodiments no greater than 5% of the pitch and/or the largest cross-sectional dimension of the connected primary non-adhesive elements.

The bridges 458 in sum typically comprises a smaller percentage of total surface area in a non-adhesive region than primary non-adhesive elements 454. In some embodiments, the sum surface area contributed by bridges is no greater than 75%, in some embodiments no greater than 55%, in some embodiments no greater than 35%, in some embodiments no greater than 15%, in some embodiments no greater than 10%, and in some embodiments no greater than 5% of the total surface area in the non-adhesive region on front surface of a backing.

The interstitial spaces 456 are coated with an adhesive; the sum area of the interstitial spaces 456 defines the adhesive region within the second adhesive distribution 410, while the sum area of the non-adhesive elements 454 and bridges 458 defines the non-adhesive region.

Another exemplary inverse pair of arranged distributions of adhesive and non-adhesive regions for use on opposing major surfaces of a backing are depicted in FIG. 10. The distributions can be used with any of the backings and mounting devices described herein and feature adhesive/non-adhesive elements arranged in opposing patterns. A first adhesive distribution 500 for use on a rear major surface of a backing (i.e., the surface opposing a mounting device) includes a plurality of primary adhesive elements 524. A second adhesive distribution 510 includes a plurality of primary non-adhesive elements 554. The adhesive and non-adhesive elements 524, 554 are circular and arranged as a tessellation, but other shapes, patterns and arrangements are also possible.

The second adhesive distribution 510 can be used to couple a mounting device to the (front) major surface of a backing. A non-adhesive region includes a plurality of primary non-adhesive elements 554 arranged in the same pattern as the adhesive islands 524 in the first adhesive distribution. Each primary non-adhesive element 554 has a similar shape to its opposing adhesive island 524, but possesses a larger area to create an overlap boundary 560 (seen in the overlap view in the central, opposed pattern 505).

Each primary non-adhesive element 554 is connected to each adjoining element 554 by a bridge 658. Each bridge 558 also lacks adhesive functionality and/or is not significantly adhesive. The bridges 558 operate to vent air from the exterior of the adhesive distribution 510 inward to the non-adhesive elements 554 in the center. Together, non-adhesive elements 554 and bridges 558 define the non-adhesive region of second distribution 510.

Each primary adhesive element 524 is connected to each adjoining element 524 by a channel 528. Each channel 528 is also adhesive. The channels 528 operate to assist the ventilation of the adhesive distribution 510 inward to the non-adhesive elements 554 in the center by “pulling” the bridges 558 in a direction normal to the axis 559 of each bridge 558. Channels 528 are typically narrower than linking bridges 558, though the channels 528 can be coextensive in other implementations. Channels 528 have a length dimension equal to the length dimension of the bridge 558 and a smaller width. Channels typically have a width of less than the pitch and/or the largest cross-sectional dimension of the primary adhesive elements 524 connected by the channel 528 and/or the pitch. In some embodiments, each channel has a width of no greater than 95% of the pitch and/or largest cross-sectional dimension of the connected primary adhesive elements and/or the pitch, in some embodiments no greater than 75%, in some embodiments no greater than 55%, in some embodiments no greater than 35%, in some embodiments no greater than 15%, in some embodiments no greater than 10%, and in some embodiments no greater than 5% of the pitch and/or the largest cross-sectional dimension of the connected primary adhesive elements 524.

In some embodiments, each channel has a width of no greater than 95% of the corresponding bridge 558, in some embodiments no greater than 75%, in some embodiments no greater than 55%, in some embodiments no greater than 35%, in some embodiments no greater than 15%, in some embodiments no greater than 10%, and in some embodiments no greater than 5% of the corresponding bridge 558.

The channels typically comprise a smaller percentage of total surface area in an adhesive region than primary adhesive elements 524. In some embodiments, the sum surface area contributed by channels is no greater than 75%, in some embodiments no greater than 55%, in some embodiments no greater than 35%, in some embodiments no greater than 15%, in some embodiments no greater than 10%, and in some embodiments no greater than 5% of the total surface area in the adhesive region on rear surface 512.

The interstitial spaces 556 are coated with an adhesive; the sum area of the interstitial spaces 556 defines the adhesive region within the second adhesive distribution 510. Conversely, the interstitial spaces 526 in first distribution 500 lack adhesive functionality and/or are not significantly adhesive. Accordingly, the sum area of the interstitial spaces 526 defines the non-adhesive region of first adhesive distribution 500.

Another exemplary inverse pair of arranged distributions of adhesive and non-adhesive regions for use on opposing major surfaces of a backing are depicted in FIG. 11. The distributions can be used with any of the backings and mounting devices described herein and feature adhesive/non-adhesive elements arranged in opposing patterns. A first adhesive distribution 600 for use on a rear major surface of a backing (i.e., the surface opposing a mounting device) includes a plurality of primary adhesive elements 624. A second adhesive distribution 610 includes a plurality of primary non-adhesive elements 654. The adhesive and non-adhesive elements 624, 654 are circular and arranged as a tessellation, but other shapes, patterns and arrangements are also possible.

The second adhesive distribution 610 can be used to couple a mounting device to the (front) major surface of a backing. A non-adhesive region includes a plurality of primary non-adhesive elements 654 arranged in the same pattern as the adhesive islands 624 in the first adhesive distribution. Each primary non-adhesive element 654 has a similar shape to its opposing adhesive island 624, but possesses a larger area to create an overlap boundary 660 (seen in the overlap view in the central, opposed pattern 605).

Each primary non-adhesive element 654 is connected to each adjoining element 654 by a bridge 658 lacking adhesive functionality and/or not being significantly adhesive. Together, non-adhesive elements 654 and bridges 658 define the non-adhesive region for the second distribution 610.

Each primary adhesive element 624 in first distribution 600 is connected to each adjoining element 624 by a channel 628; each channel 628 is also adhesive. A non-adhesive island 630 is disposed in the approximate center of each primary adhesive element 624. As depicted, the non-adhesive island 630 possesses the same shape as primary adhesive element 624, thought other geometries are possible and contemplated herein. In other implementations, a primary adhesive element 624 may include a plurality of non-adhesive islands 630 within its boundaries. The non-adhesive island may be created, for example, by lack of adhesive coating, a deadening layer or material as described below, or a perforation through the backing and relevant patterned elements. Without wishing to be bound by theory, the non-adhesive islands serve to limit the concentration of load on an adherend by forcing a peel release to occur before it reaches the center to a given adhesive area.

In some embodiments, the island 630 comprises between about 0.01% and about 20% of the total area defined in a given primary adhesive element. In some embodiments, the island 630 comprises between about 1% and about 5% of a total adhesive element area.

The interstitial spaces 626 in first distribution 600 lack adhesive functionality and/or are not significantly adhesive. Accordingly, the sum area of the interstitial spaces 626 and islands 630 define the non-adhesive region of first adhesive distribution 600. Conversely, the interstitial spaces 656 in second distribution 610 are coated with an adhesive; the sum area of the interstitial spaces 656 defines the adhesive region within the second adhesive distribution 610.

Many changes may be made to the specific embodiments shown in FIGS. 2-11 and described above. For example, each of the embodiments can have different shapes, sizes, or thicknesses. As another example, non-adhesive islands may be used in distributions without one or more of bridges and linking channels.

Any of the embodiments shown or described above or herein can have any combination of the backings, adhesives, adhesive regions, non-adhesive regions, and/or mounting devices described below. For example, the mounting device can overlap or be adjacent to multiple or a plurality of non-adhesive regions.

Backing

The backing can be made of any desired material. Representative examples of materials suitable for the backing can include, for example, polyolefins, such as polyethylene, including high density polyethylene, low density polyethylene, linear low density polyethylene, and linear ultralow density polyethylene, polypropylene, and polybutylenes; vinyl copolymers, such as polyvinyl chlorides, both plasticized and unplasticized, and polyvinyl acetates; olefinic copolymers, such as ethylene/methacrylate copolymers, ethylene/vinyl acetate copolymers, acrylonitrile-butadienestyrene copolymers, and ethylene/propylene copolymers; acrylic polymers and copolymers; polyurethanes; and combinations of the foregoing. Mixtures or blends of any plastic or plastic and elastomeric materials such as polypropylene/polyethylene, polyurethane/polyolefin, polyurethane/polycarbonate, polyurethane/polyester, can also be used.

In some embodiments, the backing may consist of one or more layers of adhesive of the type used to create adhesive regions on the corresponding major surfaces; such construction can be considered backing or carrier free. Carrier free adhesive constructions are described, for example, in US Publication No. 2016/0068722 (Schmitz-Stapela et al.); such embodiments may include adhesive and non-adhesive regions of the type described herein on either surface of an adhesive core.

In some embodiments, the backing is or includes a composite foam that includes a flexible polymeric foam layer, a first film laminated to a first major surface of the foam layer, and a second film laminated to a second, opposite major surface of the foam layer. Adhesive(s) can be attached to the films to form a structure of adhesive-film-foam-film-adhesive. The flexible polymeric foam layer can be chosen to optimize conformability and resiliency properties which are helpful when the mounting assembly is to be adhered to surfaces having surface irregularities. Such is the case with a typical wall surface. An exemplary flexible polymeric foam layer is commercially available under the trade designation “Command” from Minnesota Mining and Manufacturing Company (“3M”) of St. Paul, Minn. In some embodiments, the flexible polymeric foam layer of the flexible backing layer can include polyolefin foams which are available under the trade designations “Volextra” and “Volara” from Voltek, Division of Sekisui America Corporation, Lawrence, Mass. In some embodiments, the backing is metal or metal-like. In some embodiments, the backing is wood or wood-like.

The backing can be or include any of the materials or backings described in any of the following patent applications, all of which are incorporated in their entirety herein, Application No. 62/289,621 and WO Publication No. 2015/195344, both assigned to the present assignee. In particular embodiments, the backing can include the multilayer films featuring a core and one or more skin layers as described in PCT Application No. US2017/016039 (Runge et al.).

The backing layer can be a single layer or a multi-layer construction. In some embodiments, two or more sub-layers can be co-extruded so as to form the backing. In some embodiments, the backing is flexible.

Some embodiments include dyes or pigments in the backing layer. Some embodiments include at least one tackifier in at least one layer of the backing. Some embodiments include a plasticizing oil in one or more layers of the backing.

The backing can be any desired shape including, for example, square, rectangle, triangular, polygon, circular, quadrilateral, trapezoidal, cylindrical, half-circular, star-shaped, half-moon shaped, tetrahedral, combinations thereof, etc. In some embodiments, the backing has a size of between about 70 mm² and about 10,000,000 mm². In some embodiments, the backing has a size of between about 100 mm² and about 5,000 mm².

In some embodiments, the backing has a Young's modulus of between about 100 psi and about 100,000 psi. In some embodiments, the backing exhibits an elastic recovery of 1-100% at 10% strain as measured by ASTM D5459-95. In some embodiments, the backing exhibits an elastic recovery of 1-100% at 20% strain.

In some embodiments, the backing has a modulus of elasticity and/or a modulus of secant of between about 100 psi and about 15,000 psi as determined by at least one of ASTM D638-14 and ASTM D412-06a. In some embodiments, the backing has a modulus ranging between 100 psi and 15000 psi. In some embodiments, the modulus is greater than 100 psi, greater than 500 psi, greater than 1000 psi. In some embodiments, the backing modulus is less than 15000 psi, less than 10000 psi, less than 8,000 psi, less than 5,000 psi, less than 3,500 psi, less than 2000 psi, and less than 1500 psi.

In some embodiments, the backing can prevent or minimize substrate damage by lowering the peel force through elongation of the backing which aids in adhesive removal. In some embodiments, this can occur at peel angles ranging from 0-180 degrees. In some embodiments, when the final tape construction is peeled from the adherend at 90-180 degrees the backing elongates less than 1% during peeling. In some embodiments, when the final tape construction is peeled from the adherend at 90-180 degrees the backing elongates less than 5% during peeling. In some embodiments, when the final tape construction is peeled from the adherend at 90-180 degrees the backing elongates less than 10% during peeling. In some embodiments, when the final tape construction is peel from an adherend at 90-180 degrees the backing elongates more than 10% strain, and elastically recovers more 80% of that deformation. In some embodiments, when the final tape construction is peel from an adherend at 90-180 degrees the backing elongates more than 10% strain, and elastically recovers more 90% of that deformation. In some embodiments, when the final tape construction is peel from an adherend at 90-180 degrees the backing elongates more than 10% strain, and elastically recovers more 95% of that deformation. In some embodiments, when the final tape construction is peel from an adherend at 90-180 degrees the backing elongates more than 10% strain, and elastically recovers more 99% of that deformation.

In some embodiments, the backing and/or at least some of the backing layers are substantially optically clear. As used herein, the term “optically clear” means having a light transmission of at least about 50% and/or a haze of no greater than 40%. Some embodiments have a light transmission of at least about 75%. Some embodiments, have a haze of no greater than 20%. Both the light transmission and the haze of the backing can be determined using, for example, ASTM D1003-95.

In some embodiments, the backing has a thickness of between about 0.1 mils and about 100 mils. In some embodiments, the backing has a thickness of greater than 1 mil, greater than 5 mils, greater than 8 mils, greater than 10 mils, greater than 12 mils, greater than 15 mils, greater than 20 mils, greater than 22 mils, or greater than 24 mils. In some embodiments, the backing has a thickness of less than 100 mils, less than 90 mils, less than 80 mils, less than 75 mils, less than 70 mils, less than 65 mils, less than 60 mils, less than 55 mils, less than 50 mils, less than 45 mils, less than 40 mils, less than 38 mils, less than 35 mils, less than 32 mils, less than 30 mils, less than 28 mils, or less than 25 mils.

The backing can include a non-tacky tab, which can be grasped and pulled by a user to stretch and/or peel the tape during the removal process, so as to remove the tape from the object or substrate to which it has been affixed. The non-tacky tab can be an extension of the backing material or a detackified portion of an adhesive. The non-tacky tab can be formed from a tacky adhesive substrate using any known method of producing a non-tacky area including, e.g., applying a deadening material or process to the adhesive to render it non-tacky. Where present, the tab can be of any shape or size. The tab can be made of the same material as the backing or of a different material. In some embodiments, the tab has an area that is between about 5% and about 25% of the total area of the adhesive mounting assembly. In some embodiments, there is no obvious tab and the mounting device or hook act as the tab.

In some embodiments, the adhesive mounting assembly further includes a release liner adjacent to any exposed adhesive region(s). The release liner protects the adhesive during manufacturing, transit, and before use. When the user desires to use the adhesive assembly, the user can peel or remove the release liner to expose the adhesive. Examples of suitable liners include paper, e.g., kraft paper, or polymeric films, e.g., polyethylene, polypropylene or polyester. At least one surface of the liner can be treated with a release agent such as silicone, a fluorochemical, or other low surface energy based release material to provide a release liner. Suitable release liners and methods for treating liners are described in, e.g., U.S. Pat. Nos. 4,472,480, 4,980,443 and 4,736,048, and incorporated herein. Preferred release liners are fluoroalkyl silicone or silicone polycoated paper. The release liner can be printed with lines, brand indicia, or other information.

Adhesive

The adhesive can include any adhesive having the desired properties. The adhesive can be peelable or stretch releasable and peelable.

In some embodiments, the peelable adhesive is a pressure sensitive adhesive. A general description of useful pressure-sensitive adhesives may be found in the Encyclopedia of Polymer Science and Engineering, Vol. 13, Wiley-Interscience Publishers (New York, 1988). Additional description of useful pressure-sensitive adhesives may be found in the Encyclopedia of Polymer Science and Technology, Vol. 1, Interscience Publishers (New York, 1964). Any suitable composition, material or ingredient can be used in the pressure-sensitive adhesive. Exemplary pressure-sensitive adhesives utilize one or more thermoplastic elastomers, e.g., in combination with one or more tackifying resins. In some embodiments, the adhesive is not a pressure sensitive adhesive.

In some embodiments, the peelable adhesive layer can include at least one of rubber, silicone, or acrylic based adhesives. In some embodiments, the peelable adhesive layer can include a pressure-sensitive adhesive (PSA). In some embodiments, the peelable adhesive can include tackified rubber adhesives, such as natural rubber; olefins; silicones, such as silicone polyureas or silicone block copolymers; synthetic rubber adhesives such as polyisoprene, polybutadiene, and styrene-isoprene-styrene, styrene-ethylene-butylene-styrene and styrene-butadiene-styrene block copolymers, and other synthetic elastomers; and tackified or untackified acrylic adhesives such as copolymers of isooctylacrylate and acrylic acid, which can be polymerized by radiation, solution, suspension, or emulsion techniques; polyurethanes; silicone block copolymers; and combinations of the above. The adhesive can be, for example, any of the adhesives described in any of the following patent applications, all of which are incorporated by reference herein: PCT Patent Application Nos. 2015/035556, 2015/035960, and US 2015/034104, or provisional patent applications (assigned to the present assignee): 62/439,576, 62/289,673, and 62/289,660. Generally, any known additives useful in the formulation of adhesives may also be included. Additives include plasticizers, anti-aging agents, ultraviolet stabilizers, colorants, thermal stabilizers, anti-infective agents, fillers, crosslinkers, as well as mixtures and combinations thereof. In certain embodiments, the adhesive can be reinforced with fibers or a fiber scrim which may include inorganic and/or organic fibers. Suitable fiber scrims may include woven-, non-woven or knit webs or scrims. For example, the fibers in the scrim may include wire, ceramic fiber, glass fiber (for example, fiberglass), and organic fibers (for example, natural and/or synthetic organic fibers).

In some embodiments, the adhesive includes a tackifier. Some exemplary tackifiers include at least one of polyterpene, terpene phenol, rosin esters, and/or rosin acids.

In some embodiments, the peelable adhesive is a flowable adhesive that can be coated onto the backing. In some embodiments, the peelable adhesive is a more solid adhesive as is generally described in, for example, German Patent No. 33 31 016.

In some embodiments, adhesion properties of the adhesive can range from 0.1 N/dm to 25 N/dm. In some embodiments, adhesion properties of the adhesive can range from 0.5 N/dm to 10 N/dm. In some embodiments, adhesion properties of the adhesive can range from 1 N/dm to 5 N/dm.

In some embodiments, the peelable adhesive can provide a sheer strength of, for example, 1-20 pounds per square inch as measured by ASTM Test Method D3654M-06.

In some embodiments, the adhesive article can be peeled from at least one of the second terminal end, the first side, or the second side. In some embodiments, the adhesive article can be peeled from at least two of the second terminal end, the first side, or the second side.

In some embodiments, the peelable adhesives are tailored to achieve peel with no or minimal damage. Exemplary methods and articles for doing so are described in, for example, U.S. Pat. No. 6,835,452 and provisional patent applications filed by the present assignee under the following application numbers: 62/289,585, 62/289,660, and 62/379,812 and incorporated herein in their entirety.

In some embodiments, the peelable adhesive has a Tg of between about −125 degrees Celsius and about 20 degrees Celsius. In some embodiments, the peelable adhesive has a Tg of between about −70 degrees Celsius and about 0 degrees Celsius. In some embodiments, the peelable adhesive has a Tg of between about −60 degrees Celsius and about −20 degrees Celsius. In some embodiments, the peelable adhesive has a Tg of greater than −80 degrees Celsius, greater than −70 degrees Celsius, greater than −60 degrees Celsius, greater than −50 degrees Celsius, greater than −40 degrees Celsius, or great than −30 degrees Celsius. In some embodiments, the peelable adhesive has a Tg of less than 20 degrees Celsius, 10 degrees Celsius, 0 degrees Celsius, −10 degrees Celsius, −20 degrees Celsius, or −30 degrees Celsius.

Some peelable adhesives that can be used in the adhesive articles of the present disclosure have a storage modulus of about 300,000 Pa or greater, about 400,000 Pa or greater, about 500,000 Pa or greater, about 750,000 Pa or greater at 25° C., as determined by dynamic mechanical analysis. In other embodiments, the adhesive has a storage modulus of 500,000 Pa or less, 400,000 Pa or less, 300,000 Pa or less, or 250,000 Pa or less at 25° C., as determined by dynamic mechanical analysis.

Adhesive Regions or Elements

The adhesive region can have any desired size. In some embodiments, the adhesive region has a size of between about 60 mm² and about 500,000 mm². In some embodiments, the adhesive region has a size that is greater than 60 mm² or greater than 85 mm² or greater than 100 mm² or greater than 150 mm² or greater than 200 mm² or greater than 300 mm² or greater than 400 mm² or greater than 500 mm² or greater than 600 mm² or greater than 750 mm² or greater than 1000 mm² or greater than 1500 mm² or greater than 2000 mm² or greater than 2500 mm² or greater than 3000 mm² or greater than 3500 mm² or greater than 4000 mm² or greater than 4500 mm² or greater than 5000 mm² or greater than 5500 mm² or greater than 6000 mm² or greater than 10,000 mm² or greater than 50,000 mm² or greater than 100,000 mm² or greater than 200,000 mm² or greater than 300,000 mm² or greater than 400,000 mm². In some embodiments, the adhesive region has a size that is less than 100 mm² or less than 200 mm² or less than 300 mm² or less than 400 mm² or less than 500 mm² or less than 600 mm² or less than 750 mm² or less than 1000 mm² or less than 1500 mm² or less than 2000 mm² or less than 2500 mm² or less than 3000 mm² or less than 3500 mm² or less than 4000 mm² or less than 4500 mm² or less than 5000 mm² or less than 5500 mm² or less than 6000 mm² or less than 10,000 mm² or less than 50,000 mm² or less than 100,000 mm² or less than 200,000 mm² or less than 300,000 mm² or less than 400,000 mm²

An adhesive region can have any desired shape that provides the desired properties and/or performance. In some embodiments, the adhesive region includes a shaped portion and an unshaped portion. In some embodiments, the shaped portion has a shape selected from at least one of rectangular, pentagonal, hexagonal, triangular, quadrilateral, curved, star-shaped, conical, trapezoidal, polygonal, teardrop, and arrow-shaped. In other embodiments, as described above, the adhesive region includes an arranged pattern of adhesive elements having one or more shapes and sizes.

In some embodiments, an adhesive region comprises between about 0.01% and about 99% of a total major surface of a backing area. In some embodiments, the adhesive region comprises between about 10% and about 90% of a total surface area on a given major surface. In some embodiments, the adhesive region comprises between about 50% and about 90% of a total area on the rear major surface (i.e., between a backing and an adherend). In some embodiments, the adhesive region comprises between about 35% and about 75% of a total area on the rear major surface.

In certain embodiments, the adhesive region on the front surface of the backing (i.e., between the mounting device and the backing) can be provided by an adhesive reinforced with any of the backing materials described above (e.g., a double-sided tape) and/or with fibers or a fiber scrim.

Non-Adhesive Regions or Elements

As stated above, as used herein, the term “non-adhesive regions” refers to one or more regions of the adhesive article having a reduction in adhesive properties (peel adhesion or tack) as compared to the adhesive region(s) ranging from about 90% to about 100% as measured by ASTM D3330/3330M-04 (for peel adhesion) or ASTM D2979-01 (2009) (probe tack).

In some embodiments, the one or more non-adhesive regions have a reduction in adhesive properties (peel adhesion or tack) as compared to the adhesive region(s) of at least about 5% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 10% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 15% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 20% as measured by ASTM D3330/3330M-04 (for peel adhesion) or ASTM D2979-01(2009) (probe tack). In some embodiments, the one or more non-adhesive regions have a reduction in adhesive properties (peel adhesion or tack) as compared to the adhesive region(s) of at least about 30% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 40% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 50% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 60% as measured by ASTM D3330/3330M-04 (for peel adhesion) or ASTM D2979-01(2009) (probe tack). In some embodiments, the one or more non-adhesive regions have a reduction in adhesive properties (peel adhesion or tack) as compared to the adhesive region(s) of at least about 70% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 80% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 90% as measured by ASTM D3330/3330M-04 (for peel adhesion) or ASTM D2979-01 (2009) (probe tack). In some embodiments, the one or more non-adhesive regions have a reduction in adhesive properties (peel adhesion or tack) as compared to the adhesive region(s) of at least about 95% as measured by ASTM D3330/3330M-04 (for peel adhesion) or ASTM D2979-01(2009) (probe tack).

In some embodiments, the non-adhesive area(s) have a location and/or have a size, shape, and/or geometry that lowers and/or controls at least one of the average peel force and/or the peak peel force of the adhesive article such that the peel force of the adhesive article does not exceed the threshold for causing damage to the substrate from which the adhesive article is peeled.

The non-adhesive region can have any desired size. In some embodiments, the non-adhesive region has a size of between about 60 mm² and about 500,000 mm². In some embodiments, the non-adhesive region has a size that is greater than 60 mm² or greater than 85 mm² or greater than 100 mm² or greater than 150 mm² or greater than 200 mm² or greater than 300 mm² or greater than 400 mm² or greater than 500 mm² or greater than 600 mm² or greater than 750 mm² or greater than 1000 mm² or greater than 1500 mm² or greater than 2000 mm² or greater than 2500 mm² or greater than 3000 mm² or greater than 3500 mm² or greater than 4000 mm² or greater than 4500 mm² or greater than 5000 mm² or greater than 5500 mm² or greater than 10,000 mm² or greater than 50,000 mm² or greater than 100,000 mm² or greater than 200,000 mm² or greater than 300,000 mm² or greater than 400,000 mm². In some embodiments, the non-adhesive region has a size that is less than 100 mm² or less than 200 mm² or less than 300 mm² or less than 400 mm² or less than 500 mm² or less than 600 mm² or less than 750 mm² or less than 1000 mm² or less than 1500 mm² or less than 2000 mm² or less than 2500 mm² or less than 3000 mm² or less than 3500 mm² or less than 4000 mm² or less than 4500 mm² or less than 5000 mm² or less than 5500 mm² or less than 6000 mm² or less than 10,000 mm² or less than 50,000 mm² or less than 100,000 mm² or less than 200,000 mm² or less than 300,000 mm² or less than 400,000 mm².

A non-adhesive region can have any desired shape that provides the desired properties and/or performance. In some embodiments, the non-adhesive region has a shape selected from at least one of rectangular, pentagonal, hexagonal, triangular, quadrilateral, curved, star-shaped, conical, trapezoidal, polygonal, teardrop, and arrow-shaped. In other embodiments, as described above, the non-adhesive region includes an arranged pattern of non-adhesive elements having one or more shapes and sizes.

In some embodiments, a non-adhesive region comprises between about 0.01% and about 99% of a total area of a major surface of a backing. In some embodiments, the non-adhesive region comprises between about 10% and about 90% of a total area on the front major surface (i.e., between the mounting device and backing). In some embodiments, the non-adhesive region comprises between about 50% and about 90% of a total area on the front major surface.

The non-adhesive regions can be formed in any desired way. For example, in some embodiments, the non-adhesive region does not include an adhesive. Such embodiments can lack adhesive because no adhesive has been applied or because adhesive has been removed. For example, an adhesive may be coated on a major surface, and then a portion of the adhesive or the major surface may be cut away or otherwise removed. Alternatively, the adhesive can be pattern coated.

In other embodiments, a deadening layer is applied over at portion of an adhesive region to form a non-adhesive region. The deadening layer includes a deadening material, which decreases or eliminates the adhesiveness of the adhesive in the adhesive region. Exemplary deadening materials include, for example, glass bubbles, a film, a clear ink, a liquor, and/or an adhesive with lower adhesion properties. In some embodiments, the deadening layer has a thickness of between about 1 nm and about 1000 microns. In some embodiments, the deadening layer has a thickness of between about 1 nm and about 100 microns. In some embodiments, the deadening layer has a thickness of between about 100 nm and about 50 microns. In some embodiments, the adhesive in the non-adhesive area is treated in a way that decreases or eliminates its adhesiveness. Some exemplary treatments include, for example, radiation, UV exposure, e-beam, or other means to crosslink or detackify the adhesive. In some embodiments, a second adhesive with lower adhesion is present in the non-adhesive area.

The deadening layer can be disposed adjacent either one of or both major surfaces. When disposed adjacent the rear surface, the deadening layer can be disposed the between the adhesive and the backing, or on a surface of the adhesive opposite the backing. When disposed adjacent the front surface, the deadening layer can be disposed the between the adhesive and the backing, or between the adhesive and the mounting device.

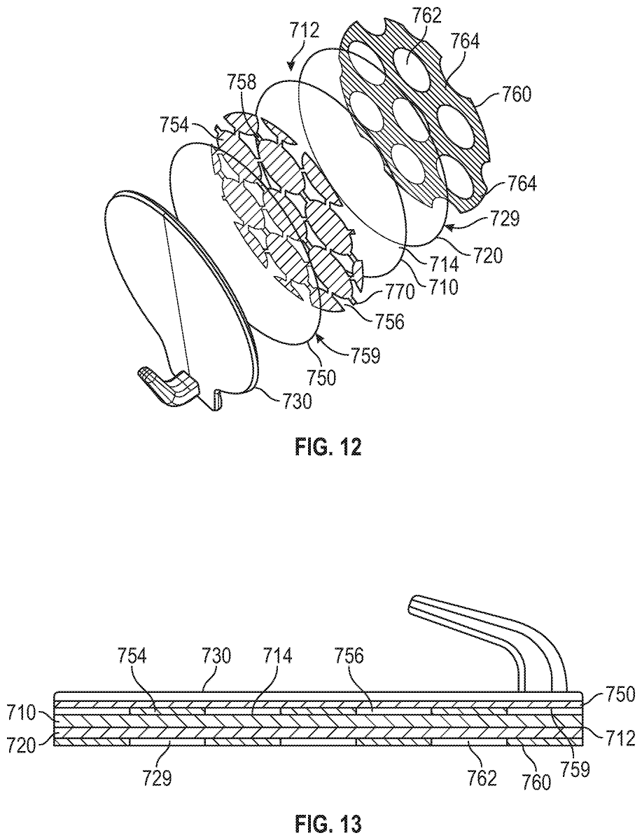

FIGS. 12 and 13 illustrate an adhesive assembly 700 featuring deadening material applied in opposing patterns on opposite sides of a backing. Adhesive mounting assembly 700 includes a backing 710 including first and second opposed major surfaces 712 and 714. The backing 710 is at least substantially planar, with each major surface 712, 714 residing in substantially parallel planes. A layer of adhesive 720 is applied to the first major surface 712, while a layer of adhesive 750 is applied to the second major surface. As depicted, each layer of adhesive 720, 750 is continuous and coextensive with the backing 710, though other constructions (e.g., an adhesive layer that is not coextensive with the backing) are possible. A first deadening layer 760 featuring a first arranged pattern of deadening material is disposed on a major surface 729 of the adhesive layer 720. A second deadening layer 770, featuring a second arranged pattern inverse to the first arranged pattern, is disposed between the mounting device 730 and a major surface 759 of the adhesive layer 750.

The first deadening layer 760 is arranged to create discrete adhesive elements on adhesive layer 720. The deadening layer 760 includes gaps 762 lacking any deadening material and interstitial space 764 surrounding the gaps 762 filled with deadening material. These gaps 762, when disposed on the adhesive layer, will create adhesive elements as described above. Gap 762 geometry and arrangement is thus selected to correspond to the desired arranged pattern of adhesive elements (e.g., adhesive islands 324 in FIG. 4) for use on the first major surface 710 of backing. The non-adhesive region created will then include both adhesive and deadening material. Accordingly, if a deadening material is used in assemblies of the present disclosure, non-adhesive elements can include an adhesive disposed between a backing and a deadening material.

The geometry and arrangement of the deadening material in the second deadening layer 770 corresponds directly to the desired arranged pattern of non-adhesive elements 754 and bridges 758. The interstitial space 756 lacks a deadening material, and so will assist in defining the adhesive region on the front major surface 714 of the backing 710.

In presently preferred implementations, the deadening layer 760 is disposed on the surface of the adhesive layer 720 opposite the rear surface 712 of the backing 710. Under certain circumstances and constructions, a deadening layer or material applied directly to the backing will not allow the backing and/or the adhesive layer(s) to stretch in a manner sufficient to avoid damage to an adherend.

Mounting Devices

The mounting device can be made of any desired material, size, or shape. Some exemplary materials include plastic, metal, rubber, glass, wood, ceramic, fabric, etc. Exemplary mounting devices include hooks, clips, magnets, detachable mechanical fasteners, snaps, and loops.

Any known mounting device can be used including, for example, any of those described herein. In some embodiments, the mounting device resembles a nail. In some embodiments, the mounting device has a single outward projection to act as a hanging surface. In some embodiments, the mounting device has multiple outward projections to act as a hanging surface. In some embodiments, the mounting device has is molded into a shape that can hold one or more items within such as but not limited to a box or caddy. In some embodiments, the mounting device is a shelf, ledge, or rack. In some embodiments, the mounting device is a bar wherein the bar can be straight or curved or substantially a ring wherein the bar can be mounted parallel or normal to the substrate surface. In some embodiments, the mounting device uses multiple methods for mounting or hanging items. Any of the following mounting devices can be suitable for use with the adhesive article of the present disclosure: Application No. 62/289,474 (assigned to the present assignee), U.S. Pat. No. 5,409,189 (Luhmann), U.S. Pat. No. 5,989,708 (Kreckel), U.S. Pat. No. 8,708,305 (McGreevy), U.S. Pat. No. 5,507,464 (Hamerski et al.), U.S. Pat. No. 5,967,474 (doCanto et al.), U.S. Pat. No. 6,082,686 (Schumann), U.S. Pat. No. 6,131,864 (Schumann), U.S. Pat. No. 6,811,126 (Johansson, et al.), U.S. Pat. No. D665,653, and U.S. Pat. No. 7,028,958 (Pitzen, et al.). The mounting device may be any object to be mounted to a substrate.

In some embodiments, the mounting device is made from thermoplastic polymers. In some embodiments, the mounting device is made from thermoset polymers. In some embodiments, the mounting device is made using polyolefin materials. In some embodiments, the mounting device is made using polycarbonate materials. In some embodiments, the mounting device is made using high-impact polystyrene. In some embodiments, the mounting device is made using acrylonitrile-butadiene-styrene (ABS) terpolymers. In some embodiments, the mounting device is made using two or more polymeric materials. In some embodiments, the mounting device is made from metal. In some embodiments, the mounting device is made from stainless steel. In some embodiments, the metal is painted, glazed, stained, brushed, or coated to alter its appearance. In some embodiments, the mounting device is made from ceramic. In some embodiments, the mounting device is made from glazed ceramic. In some embodiments, the mounting device is made from unglazed ceramic. In some embodiments, the mounting device is comprised of naturally-based materials such as wood, bamboo, particle board, cloth, canvas, or derived from biological sources, and the like. In some embodiments, the naturally-based materials may be painted, glazed, stained, or coated to change their appearance. In some embodiments, the mounting device is made using two or more materials from the list above. In some embodiments, the mounting device is made from two pieces that are reversibly or irreversibly attached, joined, or welded together.

Adhesive Assembly

Some adhesive assemblies of the present disclosure have excellent shear strength. Some embodiments of the present disclosure have a shear strength of greater than 1600 minutes as measured according to ASTM D3654-82. Some embodiments of the present disclosure have shear strength of greater than 10,000 minutes as measured according to ASTM D3654-82. Some other embodiments of the present disclosure have shear strength of greater than 100,000 minutes as measured according to ASTM D3654-82.

In some embodiments, the adhesive assembly has a thickness that is between about 0.1 mil and about 250 mils. In some embodiments, the thickness is greater than 0.1 mil, greater than 1 mil, greater than 5 mils, greater than 10 mils, greater than 15 mils, greater than 20 mils, greater than 25 mils, greater than 50 mils, greater than 75 mils, greater than 100 mils, greater than 150 mils, greater than 200 mils. In some embodiments, the thickness is less than 250 mils, less than 225 mils, less than 200 mils, less than 175 mils, less than 150 mils, less than 100 mils, less than 75 mils, less than 50 mils, less than 25 mils, less than 20 mils, less than 15 mils, or less than 10 mils.

In some embodiments, the adhesive article has a peel initiation force of between about 0.1% and 300% of the average peel force of the adhesive assembly. In some embodiments, the peel force is below 30 oz/inch at all points along the adhesive assembly.

In some embodiments, the adhesive assembly of the present disclosure exhibit enhanced conformability to a substrate or surface than prior art adhesive mounting articles. In some embodiments, the adhesive assemblies of the present disclosure hold more weight when adhered or attached to a substrate or surface than prior art adhesive mounting articles. In some embodiments, the adhesive assemblies of the present disclosure hold more weight (load/area) for a longer period of time when adhered or attached to a substrate or surface than prior art adhesive mounting articles. In some embodiments, the adhesive assemblies of the present disclosure remain adhered to a textured, rough, or irregular surface for a longer period of time than prior art adhesive mounting articles. In some embodiments, the adhesive assemblies of the present disclosure hold a higher amount of weight when adhered to a textured, rough, or irregular surface than prior art adhesive mounting articles.

In some embodiments, the adhesive assembly is substantially optically clear. Some embodiments have a light transmission of at least about 50% as measured using the method set forth in ASTM D1003-13. Some embodiments have a light transmission of at least about 75% as measured using the method set forth in ASTM D1003-13. Some embodiments have a haze of no greater than 40%. Some embodiments, have a haze of no greater than 20% as measured using the method set forth in ASTM D1003-13

In some embodiments, the adhesive assembly is substantially opaque.

In some embodiments, the adhesive assembly has a thickness that is between about 2 mils and about 250 mils. In some embodiments, the thickness is greater than 3 mils, greater than 4 mils, greater than 5 mils, greater than 8 mils, greater than 10 mils, greater than 12 mils, greater than 15 mils, or greater than 20 mils. In some embodiments, the thickness is less than 40 mils, less than 38 mils, less than 35 mils, less than 33 mils, less than 30 mils, less than 28 mils, less than 25 mils, less than 22 mils, or less than 20 mils.

In some embodiments, the peel force is below 30 oz/inch at all points along the adhesive assembly. Some adhesive assemblies of the present disclosure have a lower peel force to make the adhesive assembly easier to remove (e.g., a force between about 25 oz/in to about 50 oz/in). Some adhesive assembly of the present disclosure can have a higher peel force as to permit handling of the adhesive article by the user without accidental separation (e.g., a force between about 50 oz/in to 100 oz/in). Some embodiments of the present disclosure have a peel force between about 20 oz/in to 90 oz/in. Some embodiments of the present disclosure have a peel force between about 30 oz/in to 70 oz/in. Some adhesive articles of the present disclosure have an elongation at break of greater than 50% in at least one direction. Some adhesive assemblies of the present disclosure have an elongation at break of between about 50% and about 1200% in at least one direction.

In some embodiments, a force of between about 1N and about 50N per inch width is required to strain the adhesive assembly 10% in tensile elongation as measured according to ASTM D638-14 and/or ASTM D412-06a. In some embodiments, a force of between about 2N and about 30N per inch width is required to strain the adhesive assembly 10% in tensile elongation as measured according to ASTM D638-14 and/or ASTM D412-06a. In some embodiments, a force of between about 3N and about 15N per inch width is required to strain the adhesive assembly 10% in tensile elongation as measured according to ASTM D638-14 and/or ASTM D412-06a.

In some embodiments, the adhesive assembly exhibits an elastic recovery of greater than 70% or greater than 80% or greater than 95% at 10% strain. In some embodiments, the adhesive article exhibits an elastic recovery of greater than 70% or greater than 80% or greater than 90% at 25% strain. In some embodiments, the adhesive assembly exhibits an elastic recovery of greater than 70% or greater than 80% or greater than 90% or greater than 95% at 50% strain. In some embodiments, the adhesive article exhibits an elastic recovery of greater than 50% or greater than 70% or greater than 95% at 100% strain.

In some embodiments, the adhesive assembly has an elongation at break of at least 400%.

In some embodiments, the adhesive assembly can further include a separable connector. Some exemplary separable connectors are described in, for example, U.S. Pat. Nos. 6,572,945; 7,781,056; 6,403,206; and 6,972,141, all of which are incorporated by reference in their entirety herein.

Methods of Making

The adhesive mounting assemblies described herein can be made in various ways. In some embodiments, the adhesive can be directly coated onto a major surface of the backing. In other embodiments, the adhesive can be formed as a separate layer (e.g., coated onto a release liner) and then laminated to the backing.

Adhesive mounting assembly can be formed as a single component construction whereby, for example, the adhesive mounting assembly is cast or molded using a single material or multiple materials. Alternatively, adhesive mounting assembly can be formed as a two-component construction whereby a separately formed mounting device is adhered or attached to a separately formed backing during, for example, manufacturing or consumer use.

The adhesive can be prepared using a variety of common methods for preparing adhesives. For example, the adhesive composition can be coated onto a release liner, coated directly onto a backing, or formed as a separate layer (e.g., coated onto a release liner) and then laminated to a backing. In some embodiments, the adhesive can be formed simultaneously with the backing. For example, a multilayer film consisting of at least two layers, at least one of which is an adhesive, can be coextruded. In some embodiments, the construction can be formed in a cast or blown film construction.

To improve adhesion of the adhesive composition to the backing, the backing can be pretreated prior to applying, e.g., coating or laminating, the adhesive composition on the backing. Examples of suitable treatments include corona discharge, plasma discharge, flame treatment, electron beam irradiation, ultraviolet (UV) radiation, acid etching, chemical priming and combinations thereof. The treatment can optionally be performed with a reactive chemical adhesion promoter including, e.g., hydroxyethylacrylate, or hydroxyethyl methacrylate, or another reactive species of low molecular weight.

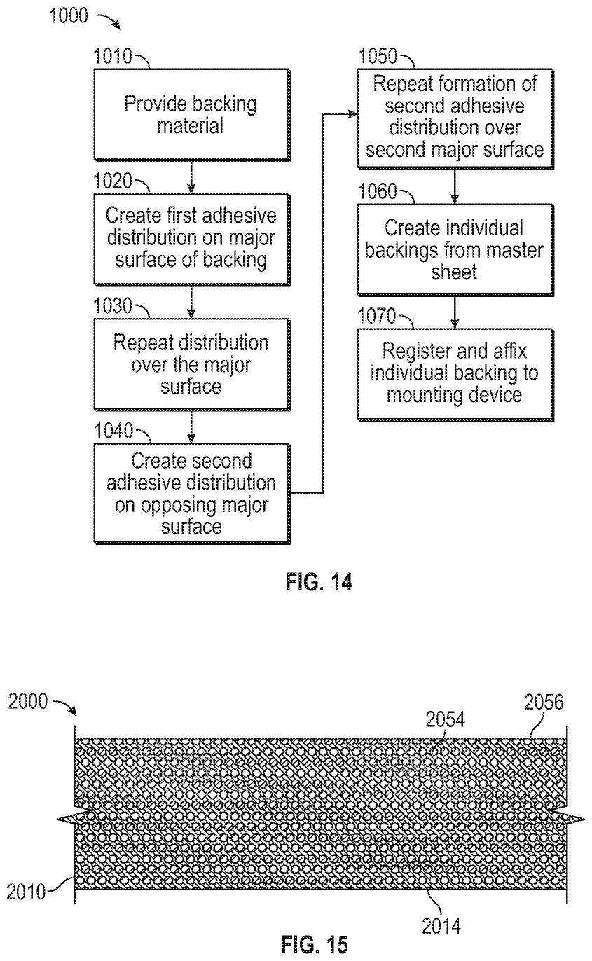

FIG. 14 describes one exemplary method of manufacturing 1000 mounting devices featuring inverse adhesive/non-adhesive regions. In Step 1010, a backing material having front and rear major surfaces is provided. The backing material can be provided as a substantially planar sheet or in the form of, e.g., a roll. Next, in Step 1020 a first adhesive distribution featuring adhesive and non-adhesive regions is created on a portion of one of the major surfaces of backing material. The distribution may include an arranged pattern of adhesive and non-adhesive elements (as in, for example, FIGS. 4-13), or may include larger regions of differing adhesive character (e.g., FIG. 2). In some embodiments, the adhesive may be applied as an adhesive fluid with any of several convenient coating techniques such as, for example, slot coating, curtain coating, notched bar coating, Meyer rod coating, flexographic printing, etc. The fluid can be cured with, e.g., thermal, UV or e-beam radiation and/or can be dried through solvent evaporation through active or passive drying. In other embodiments, the pattern of adhesive may be applied onto the backing in form of a solid layer. The pattern of adhesive can be first formed on a surface of a substrate and then be laminated onto the major surface of the backing.

In some embodiments, the application of the adhesive results in the desired non-adhesive areas being present on the major surface (e.g., the adhesive is pattern coated in the desired distribution, such that certain areas simply lack an adhesive). In other embodiments, Step 1020 includes a deadening material applied to the adhesive to create the requisite non-adhesive elements or regions. The deadening material may be applied to the backing before the adhesive is coated or otherwise affixed to the backing, such that the deadening material exists between the backing and the adhesive. In other embodiments, the deadening material is applied to a surface of the adhesive opposite the backing.

In certain embodiments, the deadening material (e.g., printing an ink pattern) can be deposited onto a release liner and transferred to an adhesive layer. In certain embodiments, the release liner is provided to cover and protect the external surface of adhesive, where the deadening material is at least partially embedded therein such that when the release liner is peeled from the adhesive, the deadening material remains with the adhesive. Peeling the release liner from the adhesive layer can simultaneously create selected areas having modified adhesive functionality. Methods for transferring a deadening material are described in provisional patent application (assigned to the present assignee) No. 62/431,124, entitled Methods of Passivating Adhesives. In Step 1030, the first adhesive distribution is repeatedly formed along the major surface of the backing. In the case of a discrete distribution as depicted in FIG. 2, the distribution does not extend the entire surface of the backing. For implementations featuring an arranged pattern of adhesive and non-adhesive elements, the first distribution may extend the full length and width of the backing, as seen in FIG. 15.

Following the completion of or concurrently with Step 1030, a second adhesive distribution featuring adhesive and non-adhesive regions is created on a portion of the opposing the major surface of backing material in Step 1040. The second adhesive distribution is configured such that the adhesive/non-adhesive character of a given element or region in the second distribution is the opposite in adhesive/non-adhesive character of the element or region across the backing in the first distribution. This arrangement assures that no adhesive regions overlap with one another along the axis extending through the thickness of the backing. The second adhesive distribution may be created in the same manner as the first adhesive distribution, or different.

In Step 1050, the second adhesive distribution is repeatedly formed along the opposing major surface of the backing. In the case of a discrete distribution as depicted in FIG. 2, the distribution does not extend the entire surface of the backing. For implementations featuring an arranged pattern of adhesive and non-adhesive elements, the first distribution may extend the full length and width of the backing. In any event, the second distribution should be registered via, for example, fiducial markings to ensure that no adhesive regions overlap with one another on opposing sides of the backing. Once registration and creation is complete, the backing represents a master sheet of adhesive coated backing film, as seen in FIGS. 15-17. A master sheet 2000, shown in top plan view in FIG. 15, includes an arranged pattern of non-adhesive islands 2054 and adhesive interstitial space 2056 across a front major surface 2014 of the backing film 2010.

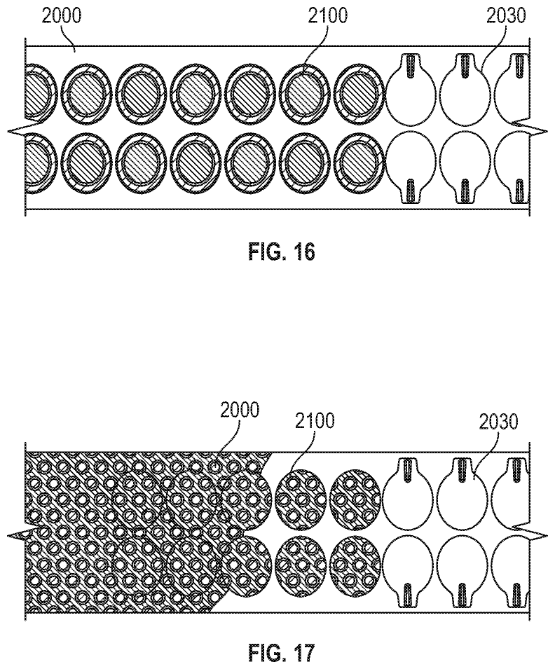

Next, in Step 1060, individual backing films are cut out of the master sheet per the shape or desired backing coverage area of a given mounting device. Individual backing films for registration with a mounting device may be created by any known method for removing material from a film, such as die cutting, laser cutting, stamping, and the like. The step of individual backing creation is illustrated for a backing including larger opposing adhesive/non-adhesive regions in FIG. 16, and a backing including arranged patterns in FIG. 17. In each, an individual film 2100 is removed from the master sheet 2000 and registered to the second major surface of a mounting device 2030.

Finally, in Step 1070, the individual film is registered to and affixed to a mounting device. In some embodiments, the film may be affixed manually to the mounting device by the end user. In other embodiments, the film is affixed to a mounting device by a manufacturer, distributor, or retailer.

Using an inverse pair of arranged patterns in method 1000 is a particularly advantageous, as the individual backing film can be cut from any portion of the master sheet. As seen in FIG. 17, the shape of the mounting device does not need to be registered to a defined area of the master sheet to have an acceptable pairing of adhesive distribution for mounting. In contrast, the master sheet of FIG. 16 requires a precise portion be removed before it can be registered with the mounting device. Moreover, the registration and correspondence of individual elements within the adhesive distribution on each side may be easier to ensure with a repeat pattern.

Methods of Using

The adhesive mounting articles of the present disclosure can be used in various ways. In some embodiments, the backing is applied, attached to, or pressed into an adherend. In this way, the backing contacts the adherend. Where a release liner is present, the release liner is removed before the backing is applied, attached to, or pressed into the adherend. In some embodiments, at least a portion of the adherend is wiped with alcohol before the backing is applied, attached to, or pressed onto the adherend.

In some embodiments, to remove the backing from the adherend, at least a portion of the backing is peeled from the adherend, as illustrated in FIGS. 8A & 8B. In embodiments where a hook is present, the user can grip the hook and use it to peel the backing from the adherend.

In some embodiments, removing the adhesive article from an adherend can be carried out by peeling the tape at a peel angle. In some embodiments, the peel angle is, for example, 90° or higher. In some embodiments, the peel angle can be lower than 90°. Removal at the appropriate peel angle can result in leaving no substantial or appreciable adhesive residue and in preventing the surface of the substrate from being damaged.

In some embodiments, to remove the backing from the adherend, at least a portion of the backing is peeled from the adherend. In embodiments where a tab is present, the user can grip the tab and use it to peel the backing from the adherend. In some embodiments, to remove the backing from the adherend, at least a portion of the backing is peeled and stretch released from the adherend.

In some embodiments, the surface to which the adherend is adhered is at least one of drywall, glass, tile, paint, veneer, wood, or other common household surfaces. In some embodiments, the surface is painted. In some embodiments, the surface is painted with a low or no VOC paint.

Advantages of this disclosure are further illustrated by the following examples, but the particular materials and amounts thereof recited in these examples, as well as other conditions and details, should not be construed to unduly limit this invention. Unless otherwise indicated, all parts and percentages are by weight.

### EXAMPLES

Test Adherends

Drywall panels (obtained from Material Company, Metzger Building, St. Paul, Minn.) were painted with Sherwin Williams Duration Matte paint obtained from the Sherwin-Williams Company of Cleveland, Ohio A first coat of paint was applied to a panel by paint roller, followed by air drying for at least 30 minutes at ambient conditions. A second coat of paint was applied and dried at ambient conditions for at least 30 minutes. Then the panel was then stored at ambient conditions for at least 7 days.

Test Sample Preparation

The adhesive mounting assembly was attached to painted drywall panel by applying firm thumb pressure contact 15 times sequentially in a 15 second time period over the entire major top plane of the hook mounting device. The test samples were left to dwell on the painted drywall panel for 24 hours.

90° Angle Peel Adhesion Test

The painted drywall panel was attached to peel fixture of INSTRON universal testing machine at a 90° peel angle (Model 5944 equipped with variable angle peel tester (2820-036), 1 kN side action pneumatic grip (2712-041), and 1 kN static load cell (2530-1 kN)). The crosshead position was zeroed at a displacement of approximately 12 inches from the top surface the painted drywall panel. A string or cable was clamped into the pneumatic grip such that the looped end was approximately 0.5 inches above the top surface of the painted drywall panel. The string was looped over the hook portion of the adhesive mounting assembly samples and was pulled at a crosshead displacement rate of 90 inches per minute. Note that for Comparative Example CE4, the hook was not robust enough to withstand the full force of peel without the hook bending and the string falling off and so the pneumatic grip was clamped directly onto the hook.

The Maximum Peel Force and Crosshead Displacement data was collected and the damage to the painted drywall panel was visually observed. The damage to the painted drywall panel was rated on 0 to 5 as defined in Table 1.

TABLE 1

| Damage Rating | Description |
|---|---|
| 0 | No visible drywall damage |
| 1 | Drywall bubble (delamination without a tear) |
| | visible, <10% of the total adhesive area |
| 2 | Drywall bubble visible, >10% of the total adhesive area |
| 3 | Dry wall tear visible, <10% of the total adhesive area |
| 4 | Drywall tear visible, between 10% and 70% of the total |
| | adhesive area |
| 5 | Dry wall tear visible, >70% of the total adhesive area |

### Example E1

An adhesive mounting assembly was prepared like that described and shown in FIGS. 12 and 13. A thin primer coating (Adhesion Promoter 4298UV, 3M Company, St. Paul, Minn.) was applied onto one side of a piece of backing film with a lint-free paper towel. The backing material used was a multilayer film featuring a core and one or more skin layers like that of Example 11 as described in PCT Application No. US2017/016039 (Runge et al.). A pressure sensitive adhesive composition was knife-coated onto a paper liner web having a silicone release surface (Loparex, Cary, N.C.). The pressure sensitive adhesive used was like that of Example B1-42 in PCT Patent Publication No. WO 2015/195620. The coating thickness of the adhesive was 2 mils. This adhesive with liner was laminated to the primed side of the backing film by feeding it twice through a HL-100 Hot Roll Laminator (Cheminstruments Fairfield, Ohio) at a pressure setting of 40 psi, a feed rate set to 20, and the roller temperature maintained at room temperature. This adhesive coated side of the backing film is further referred to as the wall-side adhesive. A thin coating of 3M 4298UV primer was then applied onto exposed side of the backing film with a lint-free paper towel (i.e., opposite the wall-side adhesive). A piece of 93010LE Laminating Adhesive with release liner (3M Company, St. Paul, Minn.) was affixed to the bed of an inkjet printer (1024 UV HS Inkjet Printer, Direct Color Systems, Rocky Hills, Conn.) with the liner side facing down and the exposed adhesive side facing up. This adhesive is further referred to as the hook-side adhesive. The hook-side pattern (Table 2) was printed onto the exposed hook-side adhesive with Magenta, UV-LED IR2 Ink #1-7115-200 (Direct Color Systems, Rocky Hills, Conn.) using standard settings, to provide uniformly coated non-adhesive regions. Without removing the piece of hook-side adhesive of the previous step from printer bed, the hook-side adhesive was then affixed to the exposed primed side of the backing film without introducing air bubbles. A squeegee was then used to firmly wipe across entire surface of the liner side of the adhesive assembly.

With the adhesive assembly still in its original position on the printer bed, the wall-side adhesive liner was removed very slowly and carefully so as not introduce stretch in the backing film/wall-side adhesive stack. This was done by sequentially pulling a quarter section of the liner at a time, while in between sequences, and reapplying force over the liner surface with the squeegee to keep the backing film/wall-side adhesive stack secured to the wall-side adhesive liner and it to the printer bed. The wall-side pattern (Table 2) was then printed onto exposed wall-side adhesive with Magenta, UV-LED IR2 Ink #1-7115-200 (Direct Color Systems, Rocky Hills, Conn.) using standard settings, to provide uniformly coated non-adhesive regions. A new piece of liner was then secured to the exposed wall-side adhesive with a squeegee. Then entire adhesive assembly was then removed from printer bed and run twice through the HL-100 Hot Roll Laminator at a pressure setting of 40 psi, a feed rate set to 20, and the roller at room temperature. A die-cutting press (25 Ton USM Samco Sb 25 Swing Arm Clicker Press) was used to die-cut the adhesive assembly into oval shapes measuring approximately 1.14 inches×1.36 inches. The hook-side liner was then removed from the oval-shaped die-cut assembly to expose the hook-side adhesive and the adhesive assembly was firmly secured to the bottom side of an injection molded hook mounting device (Injection-Molded ABS, Oval with extension, 1.19 inches×1.67 inches×0.03 inches with the root of the hook at 0.20 inches from the bottom), with uniform thumb to finger pinch pressure over the entire surface of the wall-side liner.

TABLE 2

| | | | Diameter | Diameter |
|---|---|---|---|---|
| | | Array | of Circles | of Circles |
| | | Pitch | Hook-Side | Wall-Side |
| Print Pattern | Array Type | (inches) | (mil) | (mil) |
| Multiple circles | Equilateral triangle | 0.04 | 350 | 270 |

### Example E2

An adhesive mounting assembly was prepared like that described shown in FIG. 2. The adhesive mounting assembly was prepared using the same materials and in a manner similar to that described for Example E1. The adhesive region on both the wall-side and the hook-side of the film backing includes a single generally ovular shape. A non-adhesive region (i.e., printed with ink) on the wall-side of the film backing partially surrounded a central adhesive region, defining a boundary between the adhesive and non-adhesive regions. The width of the non-adhesive region between the boundary and the perimeter of the film backing measured approximately 0.31 inches. The hook-side of the film backing included a non-adhesive region (i.e., printed with ink) measuring approximately 0.93 inches×1.15 inches, which was of a similar geometry (generally oval shape), but having a larger surface area than the corresponding central adhesive region on the wall-side of the film backing. This offset geometry created an overlap boundary region approximately 0.16 inches wide.

### Comparative Examples CE1-CE4

For comparison, adhesive mounting assembly (Comparative Example CE1) was prepared like that described for Example E1 except that with no adhesive passivation (no ink printing) on either the wall-side adhesive or hook-side adhesive (i.e., there were no non-adhesive regions). Commercially products were also tested for comparison: Comparative Example CE2=Magic Hook, 5 lb. capacity, UPC RMK2214HK, available from RoomMates, a division of York Wall Coverings, York, Pa.; Comparative Example CE3=FREESTYLE Stationary Clips, UPC U2011246, available from Elmer's Products, Inc., Westerville, Ohio; Comparative Example CE4=Party Stick Ceiling Hooks, 0.012 lb. capacity, available from The Beistle Co., Shippensburg, Pa.

The adhesive mounting assemblies of Examples E1, E2, Comparative Example CE1 and commercial product Comparative Examples CE2-CE4 were tested for 90° Angle Peel Adhesion and were visually examined for drywall damage after testing as described above.

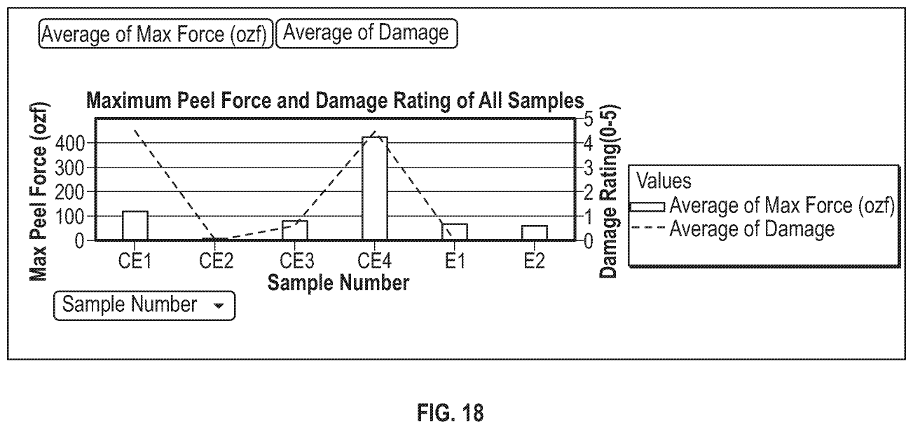

The Maximum Peel Force and Drywall Damage Rating values are reported in Table 3 and graphically depicted in FIG. 18. The Crosshead Displacement at the Maximum Peel Force is also reported in Table 3 for Examples E1, E2 and Comparative Example CE1. The values shown are the average of six replicates, except for Comparative Examples CE2, CE3 and CE4 where the number of samples tested were one, three and three, respectively.

TABLE 3

| | | | Displacement |
|---|---|---|---|
| | | | at Maximum |
| | Maximum Peel Force | Damage | Peel Force |
| Example | (ozf) | Rating | (inches) |
| E1 | 67.41 | 0 | 0.89 |
| E2 | 55.40 | 0 | 1.73 |
| CE1 | 118.84 | 5 | 0.87 |
| CE2 | 8.81 | 0 | — |
| CE3 | 82.03 | 1 | — |
| CE4 | 424.63 | 5 | — |

Examples E1 and E2 show relatively high peel forces but no drywall damage. Comparative Example CE1 shows a much higher peel force and high drywall damage. Comparative Examples CE2-CE4 samples either show very low peel force coupled with no damage or higher peel force coupled with drywall damage. The adhesive mounting assembly of Example E1 offers the additional benefit of low displacement at the maximum force, meaning that as a weight is hung on the hook, less sagging will occur due to the weight.

### Embodiments

A. An adhesive mounting assembly, comprising: a backing including opposing first and second major planar surfaces separated by a thickness; a first adhesive region on the first major planar surface of the backing, the first adhesive region exhibiting adhesive properties; a first non-adhesive region on the second major planar surface of the backing, the non-adhesive region lacking significant adhesive properties and directly opposed to first adhesive region; and a mounting device adjacent to the backing second major surface of the backing.

B. The adhesive mounting assembly of embodiment A and further comprising a second non-adhesive region on the first major surface.

C. The adhesive mounting assembly of embodiment B and further comprising a second adhesive region on the second major surface, and wherein the second adhesive region is directly opposed to the second non-adhesive region on the first major surface.

D. The adhesive mounting assembly of any of the previous embodiments, wherein the first adhesive region includes an arranged pattern of adhesive elements.

E. The adhesive mounting assembly of embodiments A or B, wherein the non-adhesive region includes an arranged pattern of non-adhesive elements, and wherein the non-adhesive elements are directly opposed to adhesive elements on the first major surface.

F. The adhesive mounting assembly of any of the previous embodiments, wherein the adhesive elements include discrete adhesive islands having a first geometry.

G. The adhesive mounting assembly of embodiment F, wherein the non-adhesive region includes an arranged pattern of non-adhesive elements, and wherein the non-adhesive elements include non-adhesive elements having a second geometry and directly opposed to adhesive islands on the first major surface.

H. The adhesive mounting assembly of embodiment G, wherein the second geometry is the same as the first geometry.

I. The adhesive mounting assembly of embodiment G, wherein the first geometry includes first dimensions, and wherein the second geometry includes second dimensions, and wherein the second dimensions are larger than the first dimensions.

J. The adhesive mounting assembly of embodiments G-I, wherein the non-adhesive region further includes bridges connecting one or more non-adhesive elements, and wherein the bridges also lack adhesive functionality.

K. The adhesive mounting assembly of embodiments G-I, wherein the backing includes a longitudinal axis, and wherein the first adhesive region and second adhesive region are not coplanar in any plane extending through the thickness of the backing and normal to the longitudinal axis.

L. The adhesive mounting assembly of embodiment K, wherein the first non-adhesive region and second non-adhesive region are not coplanar in any plane extending through the thickness and normal to the longitudinal axis.

M. The adhesive mounting assembly of embodiment A, wherein the first major surface includes a first adhesive distribution including the first adhesive region and second non-adhesive region, wherein the second major surface includes a second adhesive distribution including the second adhesive region and first non-adhesive region.

N. The adhesive mounting assembly of embodiment M, wherein the first adhesive distribution includes an arranged pattern of a plurality of adhesive elements and the interstitial spaces between adjacent adhesive elements lacks adhesive functionality and define the second non-adhesive region.

O. The adhesive mounting assembly of embodiment M or N, wherein the second adhesive distribution includes an arranged pattern of a plurality of non-adhesive elements and the interstitial spaces between adjacent non-adhesive elements are adhesive and define the second adhesive region.

P. The adhesive mounting assembly of embodiment O, wherein the adhesive elements each have a shape selected from at least one of circles, parallelograms, parallelograms with rounded corners, rectangles, squares, half-circles, ellipses, half-ellipses, triangles, trapezoids, stars, ovals, teardrops, other polygons, and combinations thereof.

Q. The adhesive mounting assembly of any of the previous embodiments, wherein the mounting device is at least one of a hook, clip, magnet, detachable mechanical fastener, snap, loop, or detachable mechanical fastener.

R. The adhesive mounting assembly of any of the preceding embodiments, wherein at least one adhesive region includes an adhesive that includes at least one of natural rubber, synthetic rubber such as SBS, SIS, SEBS, acrylate, polyurethane, silicone, silicone block copolymers, and combinations thereof.

S. The adhesive mounting assembly of any of the preceding embodiments, wherein at least one adhesive region includes an adhesive that includes a tackifier selected from a list consisting essentially of terpene phenol, polyterpene, rosin esters, rosin acids, C5 tackifiers, and/or C9 tackifiers.

T. The adhesive mounting assembly of any of the preceding embodiments, wherein the backing includes: a core layer comprising at least one of an elastomeric material, an elastomeric polymer, SEBS, SEPS, SIS, SBS, polyurethane, ethyl vinylacetate (EVA), ethyl methyl acrylate (EMA) ultra low linear density polyethylene (ULLDPE), hydrogenated polypropylene, and combinations or blends thereof; and one or more skin layers comprising at least one of polypropylene, polyethylene, high density polyethylene (HDPE), low density polyethylene (LDPE), linear low density polyethylene (LLDPE), a polyurethane, EVA, EMA, an adhesive, and combinations or blends thereof, wherein the backing has a core to skin ratio of between about 2:1 and about 100:1; and wherein the backing has a modulus of elasticity and/or a modulus of secant of between about 100 psi and about 18,000 psi as determined by at least one of ASTM D638-14 and ASTM D412-06a.

U. The adhesive mounting assembly of any of the preceding embodiments, and further comprising a second adhesive region on the second major surface, wherein the second adhesive region comprises a reinforced adhesive.

V. The adhesive mounting assembly of any of the preceding embodiments, wherein the non-adhesive region includes a deadening layer that substantially diminishes the adhesive properties of the adhesive and wherein the deadening layer is located adjacent to the adhesive.

W. The adhesive mounting assembly of embodiment V, wherein the deadening layer has a thickness of between about 0.1 mil and about 10 mils.

X. The adhesive mounting assembly of any of embodiments V-W, wherein the deadening layer comprises at least one of a coating, a film, ink, lacquer, and/or a chemical reaction initiated by radiation.

Y. The adhesive mounting assembly of any of the preceding embodiments, wherein the adhesive is peelable.

Z. The adhesive mounting assembly of any of the preceding embodiments, wherein the first non-adhesive region comprises between about 10% and about 90% percent of a total area of the second major surface.

AA. The adhesive mounting assembly of any of the preceding embodiments, wherein the first non-adhesive region comprises between about 50% and about 90% percent of the total area.

BB. The adhesive mounting assembly of any of the preceding embodiments, wherein the first adhesive region comprises between about 10% and about 90% percent of a total area of the first major surface.

CC. The adhesive mounting assembly of any of the preceding embodiments, wherein the first adhesive region comprises between about 50% and about 90% percent of the total area.

DD. The adhesive mounting assembly of any of the preceding embodiments, wherein the mounting device is capable of holding at least 0.3 pounds.

EE. The adhesive mounting assembly of any of the preceding embodiments, wherein the non-adhesive region at least one of (1) lacks a pressure sensitive adhesive; (2) includes a deadening layer that minimizes or eliminates the adhesion of the pressure sensitive adhesive in the non-adhesive region; and/or (3) has undergone an adhesive degradation process.

FF. The adhesive mounting assembly of embodiment EE, wherein the adhesive degradation process is one of radiation exposure, UV, ebeam, or other chemical transformations.

GG. The adhesive mounting assembly of any of the preceding embodiments, wherein the assembly has a sheer capacity of at least 1 lb. per square inch.

HH. The adhesive mounting assembly of any of the preceding embodiments, wherein the adhesive is peelable.

II. The adhesive mounting assembly of any of the preceding embodiments, wherein the assembly removes from an adherend damage-free.

JJ. The adhesive mounting assembly of embodiment II, wherein the adherend is painted wallboard, and wherein the paint has a sheen ranging from flat or matte to gloss.

KK. The adhesive mounting assembly of embodiment A, wherein the adhesive region includes an arranged pattern of adhesive elements, wherein the elements are arranged in an array having a transverse axis and a longitudinal axis.

LL. The adhesive mounting assembly of embodiment KK, wherein the boundary regions of any two adjacent elements in the array do not overlap.

MM. The adhesive mounting assembly of embodiments KK-LL, wherein the major surface includes interstitial space between any two elements in the array.

NN. The adhesive mounting assembly of embodiment A, wherein the non-adhesive region includes an arranged pattern of non-adhesive elements, wherein the elements are arranged in an array having a transverse axis and a longitudinal axis, and wherein the second major surface includes interstitial space between any two non-adhesive elements in the array.

OO. A method of forming an adhesive mounting assembly, comprising:

providing a backing including opposing first and second planar surfaces separated by a thickness; forming a first adhesive region and a first non-adhesive region on the first major planar surface of the backing; the first adhesive regions including a peelable adhesive; forming a second adhesive region and a second-non-adhesive region on the second major surface; and providing a mounting device adjacent to the second major planar surface of the backing; wherein a non-adhesive region on a given major planar surface is directly opposed by a corresponding adhesive region.

PP. The method of embodiment OO, wherein forming the first adhesive region comprises applying a peelable adhesive on the first major planar surface of the backing.

QQ. The method of any of embodiments OO-PP, wherein forming at least one of the first and second non-adhesive region adhesive regions comprises including a deadening layer that minimizes or eliminates the adhesion of the adhesive.

RR. The method of any of embodiments OO-QQ, wherein forming the first and second adhesive regions comprises degrading the peelable adhesive in the non-adhesive regions.

SS. The method of any of embodiments OO-RR, wherein degrading the adhesive involves at least one of radiation exposure, chemical degradation, and mechanical degradation.

TT. A method of using an adhesive mounting device, comprising:

adhering the adhesive mounting assembly of any of embodiments A-NN to a surface; and

removing the adhesive article from the surface.

UU. The method of embodiment TT, further comprising:

removing a release liner from the adhesive mounting assembly before adhering it to the surface.

VV. The method of any of embodiments TT-UU, wherein removal of the adhesive assembly from the surface involves peeling the adhesive article from the surface.

XX. The method of any of embodiments TT-VV, wherein the surface is at least one of drywall, glass, tile, paint, veneer, wood, or the like.

YY. A method of forming an adhesive mounting assembly, comprising: providing a backing including opposing first and second planar surfaces separated by a thickness; forming a first adhesive region and a first non-adhesive region on the first major planar surface of the backing; the first adhesive regions including a peelable adhesive; forming a second adhesive region and a second-non-adhesive region on the second major surface of the backing to create a master sheet; providing a mounting device having a major surface with a first geometry; and removing a portion of the master sheet corresponding to the first geometry to create a discrete backing; and placing the backing adjacent to the major surface of the mounting device.

ZZ. The method of embodiment YY, wherein removing a portion includes at least one of die cutting, laser cutting, and stamping.

A*. The method of embodiment YY, wherein forming the first adhesive region and first non-adhesive region comprises creating a first adhesive distribution featuring an arranged pattern of adhesive elements, and wherein forming the second adhesive region and non-adhesive region comprises creating a second adhesive distribution featuring an arranged pattern of non-adhesive elements corresponding in geometry to the adhesive elements in the first distribution.

B*. The method of embodiment A*, wherein removing a portion of the master sheet further comprises selecting the portion to be removed from any area of the master sheet.

The terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

All references mentioned herein are hereby incorporated by reference in their entirety.

Those having skill in the art will appreciate that many changes may be made to the details of the above-described embodiments and implementations without departing from the underlying principles thereof. Further, various modifications and alterations of the present invention will become apparent to those skilled in the art without departing from the spirit and scope of the invention. The scope of the present application should, therefore, be determined only by the following claims and equivalents thereof.

1. An adhesive mounting assembly, comprising:
a backing including opposing first and second major planar surfaces separated by a thickness;
a first adhesive region on the first major planar surface of the backing, the first adhesive region exhibiting adhesive properties and including an arranged pattern of adhesive islands having a first geometry;
a first non-adhesive region on the second major planar surface of the backing, the non-adhesive region lacking significant adhesive properties and directly opposed to first adhesive region; and
a mounting device adjacent to the backing second major surface of the backing,
wherein the first non-adhesive region includes an arranged pattern of non-adhesive elements, and wherein the non-adhesive elements have a second geometry and are directly opposed to the adhesive elements on the first major surface.

2. The adhesive mounting assembly of claim 1 and further comprising a second non-adhesive region on the first major surface.

3. The adhesive mounting assembly of claim 2 and further comprising a second adhesive region on the second major surface, and wherein the second adhesive region is directly opposed to the second non-adhesive region on the first major surface.

4-5. (canceled)

6. The adhesive mounting assembly of claim 4, wherein the adhesive elements include discrete adhesive islands having the first geometry.

7. (canceled)

8. The adhesive mounting assembly of claim 1, wherein the first geometry includes first dimensions, and wherein the second geometry includes second dimensions, and wherein the second dimensions are larger than the first dimensions.

9. The adhesive mounting assembly of claim 1, wherein the non-adhesive region further includes bridges connecting one or more non-adhesive elements, and wherein the bridges also lack adhesive functionality.

10. The adhesive mounting assembly of claim 1, wherein the backing includes a longitudinal axis, and wherein the first adhesive region and second adhesive region are not coplanar in any plane extending through the thickness of the backing and normal to the longitudinal axis.

11. The adhesive mounting assembly of claim 10, wherein the first non-adhesive region and second non-adhesive region are not coplanar in any plane extending through the thickness and normal to the longitudinal axis.

12. The adhesive mounting assembly of claim 1, wherein the first major surface includes a first adhesive distribution including the first adhesive region and a second non-adhesive region, wherein the second major surface includes a second adhesive distribution including a second adhesive region and the first non-adhesive region, and wherein the first adhesive distribution includes the arranged pattern of a plurality of adhesive elements and the interstitial spaces between adjacent adhesive elements lacks adhesive functionality and define the second non-adhesive region.

13. The adhesive mounting assembly of claim 12, wherein the second adhesive distribution includes the arranged pattern of a plurality of non-adhesive elements and the interstitial spaces between adjacent non-adhesive elements are adhesive and define the second adhesive region.

14. The adhesive mounting assembly of claim 1, wherein the non-adhesive region includes a deadening layer that substantially diminishes the adhesive properties of the adhesive and wherein the deadening layer is located adjacent to the adhesive.

15. The adhesive mounting assembly of claim 1, wherein the deadening layer comprises at least one of a coating, a film, ink, lacquer, and/or a chemical reaction initiated by radiation.

16. The adhesive mounting assembly of claim 1, wherein the non-adhesive region at least one of (1) lacks a pressure sensitive adhesive; (2) includes a deadening layer that minimizes or eliminates the adhesion of the pressure sensitive adhesive in the non-adhesive region; and (3) has undergone an adhesive degradation process.

17. The adhesive mounting assembly of claim 1, wherein the assembly removes from an adherend damage-free, and wherein the adherend is painted wallboard, and wherein the paint has a sheen ranging from flat or matte to gloss.

18. The adhesive mounting assembly of claim 1, wherein the elements are arranged in an array having a transverse axis and a longitudinal axis, and wherein the boundary regions of any two adjacent elements in the array do not overlap.

19. A method of forming an adhesive mounting assembly, comprising:
providing a backing including
opposing first and second planar surfaces separated by a thickness;
forming a first adhesive region and a first non-adhesive region on the first major planar surface of the backing; the first adhesive regions including a peelable adhesive;
forming a second adhesive region and a second-non-adhesive region on the second major surface; and
providing a mounting device adjacent to the second major planar surface of the backing;
wherein a non-adhesive region on a given major planar surface is directly opposed by a corresponding adhesive region.

20. The method of any of claim 19, wherein forming at least one of the first and second non-adhesive region adhesive regions comprises including a deadening layer that minimizes or eliminates the adhesion of the adhesive.

21. The method of any of claim 19, wherein forming the first and second adhesive regions comprises degrading the peelable adhesive in the non-adhesive regions, wherein degrading the adhesive involves at least one of radiation exposure, chemical degradation, and mechanical degradation.

22. A method of forming an adhesive mounting assembly, comprising:
providing a backing including opposing first and second planar surfaces separated by a thickness;
forming a first adhesive region and a first non-adhesive region on the first major planar surface of the backing; the first adhesive regions including a peelable adhesive;
forming a second adhesive region and a second-non-adhesive region on the second major surface of the backing to create a master sheet;
providing a mounting device having a major surface with a first geometry;
and removing a portion of the master sheet corresponding to the first geometry to create a discrete backing; and placing the backing adjacent to the major surface of the mounting device.

23. The method of claim 22, wherein forming the first adhesive region and first non-adhesive region comprises creating a first adhesive distribution featuring an arranged pattern of adhesive elements, and wherein forming the second adhesive region and non-adhesive region comprises creating a second adhesive distribution featuring an arranged pattern of non-adhesive elements corresponding in geometry to the adhesive elements in the first distribution.
